(19) United States
(12) Patent Application Publication
(10) Pub. No.: US 2025/0296660 A1
(43) Pub. Date: Sep. 25, 2025

(54) GNSS-INDEPENDENT MOTION AIM CONTROL AND EFFECTOR TIMING

(71) Applicant: IXI Technology Holdings, Inc., Yorba Linda, CA (US)

(72) Inventors: Daniel Hyman, Long Beach, CA (US); Michael Dekoker, Eastvale, CA (US); Micah Ting, Tustin, CA (US); Byron del Castillo, Eastvale, CA (US)

(21) Appl. No.: 19/083,358

(22) Filed: Mar. 18, 2025

Related U.S. Application Data
(60) Provisional application No. 63/566,877, filed on Mar. 18, 2024.

(51) Int. Cl. B63B 22/00; G01C 21/16; G01S 19/14

(52) U.S. Cl. CPC B63B 22/00; G01C 21/16; G01S 19/14; B63B 2022/006

(57) ABSTRACT

A method of transmitting communications from a buoy placed in a body of water having the steps of: first determining a first orientation of the buoy relative to a communication target; second determining a second orientation of the buoy relative caused by the body of water; third determining whether a transmission can reach the communication target; and transmitting communications in a directional manner to the communication target if the step of determining determines that a transmission can reach the communication target. A sense control unit is likewise disclosed as are various systems and methods.

### CROSS-REFERENCE TO RELATED APPLICATION

The present application claims priority from U.S. Patent App. Ser. No. 63/566,877 filed Mar. 18, 2024, entitled “GNSS-INDEPENDENT MOTION AIM CONTROL AND EFFECTOR TIMING”, the entire disclosure of which is incorporated by reference in its entirety.

### BACKGROUND OF THE DISCLOSURE

### 1. Field of the Disclosure

The disclosure relates in general to electronics, and more particularly, to a sense and control system.

### 2. Background Art

Aiming control systems including camera positioners and antenna control units (ACUs) detect the position and orientation of a platform and then issue control commands to actuators or electronically steered effectors to maintain the aim direction. Typically, inertial sensors such as gyroscopes and accelerometers are combined into an overall inertial measurement unit (IMU) which is then combined with input from the Global Positioning System (GPS) or other nation-specific Global Navigation Satellite System (GNSS) broadcasts that are received and analyzed to locate the platform and provide additional positioning, navigation, and timing (PNT) resources. The sensor input is analyzed by a computer or dedicated processor such as a microcontroller unit (MCU) and a vector is determined to define the direction needed to orient actuators or effectors towards a desired target. These calculations can be made relative to global location or made relative to the position and orientation of the local platform irrespective of global coordinates.

Multiple developers have created sensors, GNSS receivers, processing components, command translators, and orientation actuators that are all part of the payload aiming market and both commercial and defense ecosystems. A subsystem containing IMU, PNT, MCU, and ACU elements may be referred to as a Controller. A common limitation to many Controllers is that the IMU elements are subject to significant sensor drift and are unreliable over seconds to minutes of operation without correlation and correction by GNSS PNT services. An additional common limitation is that some applications for Controllers require additional sensitivity to the dynamics of the local environment, such as ocean swells and waves, turbulence, or rough terrain that is generally not able to be assessed accurately by either GNSS or terrestrial PNT correction services.

The marketplace for unattended sensors and uncrewed vehicles is expected to grow significantly with the democratization of artificial intelligence (A.I.) and machine learning (M.L.) capabilities available at low cost. One problem that hampers the deployment of power-hungry A.I. processing and high-power datalinks to feed M.L. processing centers is the widespread availability of wireless links with high gain and throughput, cameras that aim and steady themselves while on-the-move, imaging-quality radar that operates on moving vehicles, and targeting equipment for signals intelligence, electronic warfare, and kinetic response payloads that require stability and reliability. It is highly desirable that critical civilian infrastructure, logistics, security, and defense subsystems work properly even in GNSS-denied or spoofed conditions commonly encountered around criminal enterprises and hostile combatants.

### SUMMARY OF THE DISCLOSURE

The disclosure is directed to a sense-control unit comprising at least one IMU, at least one magnetometer, at least one MCU, and at least one structure configured for control commands to be issued. The at least one IMU and at least one magnetometer orientations are fixed relative to the unit body including both electrical and mechanical connections. The at least one IMU and at least one magnetometer electrical connections include a structure configured for providing data access to at least one MCU. The at least one MCU executes translation system methods that translate the data from the at least one IMU and at least one magnetometer into a vector representation of the orientation and motion of the platform. At least one MCU executes control system methods that create control commands that, when followed by an appropriate aiming device, results in the aiming of the device towards a target direction. At least one MCU executes effector timing system methods that tracks the IMU motion data to determine when an appropriate time is to operate elements coupled to the aiming device to effectuate a desired outcome using at least one selected mode of operation.

In some configurations, at least one IMU, at least one magnetometer, at least one MCU, and at least one structure configured to communicate control commands comprise components that have been designed into a printed circuit board (PCB) and then populated to form a printed circuit board assembly (PCBA).

In some configurations, the PCB includes electrically conductive materials to electrically and mechanically couple signal between one or more IMU to one or more MCU, between one or more magnetometer to one or more MCU, and between one or more MCU and at least one structure configured to communicate control commands.

In some configurations, the conductive material is at least one of copper, silver, aluminum, nickel, gold, an alloy of at least one of copper, silver, aluminum, nickel, gold, and a solder compatible with at least one of copper, silver, aluminum, nickel, and gold used to electrically and mechanically couple components to the conductive traces of the PCB.

In some configurations, at least one IMU incorporates sensor elements that measure acceleration in each of three cardinal directions relative to the package body.

In some configurations, at least one IMU incorporates sensor elements that measure rotational acceleration around each of three axial directions relative to the package body.

In some configurations, at least one IMU incorporates PNT resources including but not limited to at least one GNSS receiver circuit.

In some configurations, at least one IMU incorporates PNT resources including but not limited to at least one GNSS receiver circuit.

In some configurations, the structure configured for providing data access from at least one IMU to at least one MCU is by serial communications between the IMU and MCU.

In some configurations, the structure configured for providing data access from at least one IMU to at least one MCU is by parallel communications between the IMU and MCU.

In some configurations, the structure configured for providing data access from at least one IMU to at least one MCU is by having the IMU write data to a memory bank and having the MCU separately access the memory bank.

In some configurations, at least one magnetometer incorporates sensor elements that measure acceleration in each of three cardinal directions relative to the package body.

In some configurations, at least one magnetometer incorporates PNT resources including but not limited to at least one GNSS receiver circuit.

In some configurations, the structure configured for providing data access from at least one magnetometer to at least one MCU is by serial communications between the magnetometer and MCU.

In some configurations, the structure configured for providing data access from at least one magnetometer to at least one MCU is by parallel communications between the magnetometer and MCU.

In some configurations, the structure configured for providing data access from at least one magnetometer to at least one MCU is by having the magnetometer write data to a memory bank and having the MCU separately access the memory bank.

In some configurations, the control commands created by the MCU executing control system methods are comprised of commands that drive a pan-tilt-zoom assembly of actuators directly.

In some configurations, the control commands created by the MCU executing control system methods are comprised of commands that interface with a pan-tilt-zoom motor controller that itself drives an assembly of actuators.

In some configurations, the control commands created by the MCU executing control system methods are comprised of commands that drive an electronically steered aperture (ESA) directly.

In some configurations, the control commands created by the MCU executing control system methods are comprised of commands that interface with a control circuit that itself drives an ESA.

In some configurations, the control circuit that drives an ESA is comprised of a programmable logic device that includes one or more of a Simple Programmable Logic Device (SPLD), complex programmable logic device (CPLD), and field programmable gate array (FPGA),

In some configurations, the vector representation of the orientation and motion of the platform include a definition of the orientation of the platform that is relative to gravity of the Earth defining down and relative to magnetic field of the Earth defining Magnetic North.

In some configurations, the vector representation of the orientation and motion of the platform include a definition of the orientation of the platform relative to a target aim direction.

In some configurations, the vector representation of the orientation and motion of the platform include a definition of the orientation and PNT location of the platform relative to a target aim location.

In some configurations, the vector representation of the orientation and motion of the platform is in reference to a calculated North that differs from Magnetic North based on the most recently available PNT data.

In some configurations, the most recently available PNT data was provided by a data upload from a trusted PNT source.

In some configurations, the most recently available PNT data was provided by on-board PNT resources.

In some configurations, the most recently available PNT data from on-board PNT resources is historical data rather than recently polled data.

In some configurations, the translation system methods, control system methods, and effector timing system methods are all executed on the same processor within an MCU component.

In some configurations, the translation system methods, control system methods, and effector timing system methods are executed across two or more processors co-located within the same MCU component with a provided structure configured to share data.

In some configurations, the translation system methods, control system methods, and effector timing system methods are executed across two or more processors located within different MCU components with a provided structure configured to share data.

In some configurations, the translation system methods, control system methods, and effector timing system methods are executed on the same processor of an MCU component but structure configured to communicate control commands are provided by a separate processor with a provided structure configured to share data.

In some configurations, the effector timing system methods that track the IMU motion data is comprised of at least one of water swell and wave detection methods to detect position relative to the peak or trough of the platform.

In some configurations, the at least one of water swell and wave detection methods detect velocity over integrated periods of time and determine proximity to peaks and troughs based on periods of time with positive velocity vs. negative velocity.

In some configurations, the at least one of water swell and wave detection methods use the position of the platform relative to the peak or trough to select a mode of operation for at least one effector.

In some configurations, the at least one of water swell and wave detection methods estimate the total water height difference between the peak and trough.

In some configurations, the at least one of water swell and wave detection methods use the total water height difference between the peak and trough to select a mode of operation for at least one effector.

In some configurations, the position of the platform at or near a water peak is used to select a mode of operation known to have high performance with direct line of sight (LOS) between the effector and the target.

In some configurations, the position of the platform at or near a water trough is used to select a mode of operation known to have performance without requiring direct LOS between the effector and the target.

In some configurations, the at least one of water swell and wave detection methods use the total water height difference between the average experienced peaks and troughs to correlate to a particular designation of sea state.

In some configurations, the at least one of water swell and wave detection methods use the designation of sea state to change the available set of modes of operation for at least one effector.

In some configurations, the at least one of water swell and wave detection methods are able to differentiate between a global water apex and a local water apex and select a mode of operation for at least one effector based on this differentiation.

In some configurations, the at least one of water swell and wave detection methods are able to differentiate between a global water trough and a local water trough and select a mode of operation for at least one effector based on this differentiation.

In some configurations, one or more sensors are used to detect the presence of an obstruction immediately adjacent to one or more elements of one or more effectors.

In some configurations, the presence of an obstruction immediately adjacent to one or more elements of one or more effectors may negatively impact intended outcome of an attempt to enact an effect.

In some configurations, an adjacent obstruction that can negatively impact outcome of an effector operation is a significant volume of liquid water, which may adversely impact the operation of one of more adjacent/submerged radio frequency antennas, optical lenses, or weapon systems.

In some configurations, an adjacent obstruction that can negatively impact outcome of an effector operation is one or more of a significant volume of soil, dust, or rocks.

In some configurations, an adjacent obstruction that can negatively impact outcome of an effector operation is detrimental foliage.

In some configurations, an adjacent obstruction that can negatively impact outcome of an effector operation is one or more persons or animals.

In some configurations, the effector timing system methods that track the IMU motion data is comprised of at least one terrain estimation method to detect motion of the platform relative to physical obstructions of effectors to determine appropriate times to operate effector elements in one or more selected modes.

In some configurations, at least one terrain estimation method estimates local position compared to pre-loaded map terrain data.

In some configurations, at least one terrain estimation method estimates local position without using recent PNT data by correlating dynamic orientation and position changes experienced by the platform to pre-loaded terrain data.

In some configurations, at least one terrain estimation method estimates local position based on timewise relevant orientation and travel conditions compared to pre-loaded map topographic data.

In some configurations, the effector timing system methods that track the IMU motion data is comprised of at least one of turbulence methods to detect motion of the platform relative to targeting characteristics of effectors to determine appropriate times to operate effector elements in one or more selected modes.

In some configurations, one or more turbulence methods determine if the motion of the platform exceeds motion limits required for proper effector operation.

In some configurations, one or more turbulence methods determine if the motion of the platform requires one or more effectors to operate in at least one selected mode known to function in a beneficial manner during the period of time the motion is experienced.

In some configurations, the structure configured to communicate control commands includes one or more radio-frequency communications modules.

In some configurations, the structure configured to communicate control commands includes one or more optical-frequency communications modules.

In some configurations, the structure configured to communicate control commands includes one or more wired serial data ports.

In some configurations, the structure configured to communicate control commands includes one or more wired parallel data ports.

In some configurations, the structure configured to communicate control commands includes one or more wired general purpose input/output (I/O) lines.

In some configurations, the at least one effector includes a radio frequency communications subsystem.

In some configurations, the at least one effector includes a radio frequency sensor subsystem.

In some configurations, a radio frequency sensor subsystem is used to provide a vector to an external known fixed object having a radio frequency response to enable local platform PNT correction.

In some configurations, a radio frequency sensor subsystem is first used to target a fixed object for PNT correction of the platform and is subsequently aimed towards a different object for radio frequency sensing.

In some configurations, the at least one effector includes an optical communications subsystem such as an infrared light-emitting device (LED) communicator or laser radio.

In some configurations, the at least one effector includes an optical sensing subsystem such as a camera, electro-optical infrared (EO/IR), light detecting and ranging (LADAR), or laser imaging, detection, and ranging (LIDAR) sensor.

In some configurations, the at least one effector includes an optical sensing subsystem such as a light detecting and ranging (LADAR) or laser imaging, detection, and ranging (LIDAR) sensor.

In some configurations, the at least one effector includes a targeting subsystem such as a targeting laser.

In some configurations, a targeting laser is used to provide a vector to an external known fixed object to enable local platform PNT correction.

In some configurations, a targeting laser is first used to target a fixed object for PNT correction of the platform and is subsequently aimed towards a different object for targeting purposes.

In some configurations, the at least one effector includes a kinetic-based weapon such as an XM250 light machine gun, M240 machine gun, Mk 47 Striker grenade launcher, Close Combat Missile System-Heavy (CCMS-H) or Tube-launched, Optically tracked, Wire-guided (TOW) missile launcher.

In another aspect of the disclosure, the disclosure is directed to a method of transmitting communications from a buoy placed in a body of water comprising the steps of: first determining a first orientation of the buoy relative to a communication target; second determining a second orientation of the buoy relative caused by the body of water; third determining whether a transmission can reach the communication target; and transmitting communications in a directional manner to the communication target if the step of determining determines that a transmission can reach the communication target.

In some configurations, the step of second determining further comprises the steps of: determining one of the water swell and wave detection to determine proximity of the buoy to at least one of a peak or trough.

In some configurations, the step of second determining further comprises the step of detecting velocity over integrated periods of time to determine periods of time with one of positive velocity and negative velocity.

In some configurations, the step of transmitting communications further comprises the step of selecting a radio mode.

In some configurations, the step of selecting the radio mode comprises the selection of a low data rate radio mode.

In some configurations, the step of selecting the radio mode comprises the step of selection of a high data rate radio mode.

In some configurations, the step of second determining further comprises the step of determining one of a global water apex and a local water apex.

In some configurations, the step of transmitting communications further comprises the step of selecting a radio mode between a low data rate radio mode and a high data rate radio mode.

In some configurations, the step of second determining further comprises the step of height determining a total height difference between the peak and trough.

In some configurations, the step of height determining further comprises the step of designating a sea state.

In some configurations, the step of third determining further comprises the step of determining the presence of an adjacent obstruction to at least one antenna associated with the step of transmitting.

In some configurations, the step of third determining further comprises the step of determining if the adjacent obstruction is selected from one of the group consisting of: a volume of liquid water on the buoy, a volume of soil, dust or rocks, and foliage.

In another aspect of the disclosure the disclosure is directed to a sense-control unit. The unit includes a body; at least one inertial measurement unit (IMU) fixed to the body; at least one magnetometer fixed to the body; at least one microcontroller unit (MCU), structurally configured to issue control commands, and being coupled to the at least one IMU and the at least one magnetometer; and at least one antenna structurally configured to transmit communication upon direction of the at least one microcontroller unit. The at least one MCU based upon information from the at least one IMU and the at least one magnetometer, determines a vector representation of the orientation and motion of the body. Additionally, the at least one MCU is configured to transmit communication through the at least one antenna upon determination of the acceptability of the same.

In some configurations, the at least one IMU, the at least one magnetometer and the at least one MCU are on the same printed circuit board (PCB).

In some configurations, the IMU further includes a sensor element that is structurally configured to measure acceleration in each of three cardinal directions relative to the body.

In some configurations, the IMU further includes second sensor elements that are structurally configured to measure rotational acceleration around each of three axial directions relative to the body.

In some configurations, the sense-control unit further includes a positioning, navigation and timing (PNT) unit.

In some configurations, the PNT unit further includes a Global Navigation Satellite System (GNSS) receiver.

In some configurations, the body is one of a vehicle and a buoy.

In some configurations, the at least one antenna further includes at least one sensor to determine the presence of an adjacent obstruction to the at least one antenna.

### BRIEF DESCRIPTION OF THE DRAWINGS

The disclosure will now be described with reference to the drawings wherein:

FIG. 1a illustrates a cross-sectional schematic illustration of an ocean swell detection method in accordance with at least one configuration disclosed herein;

FIG. 1b illustrates a cross-sectional schematic illustration of an ocean swell detection method in accordance with at least one configuration disclosed herein;

FIG. 1c illustrates a cross-sectional schematic illustration of an ocean swell detection method in accordance with at least one configuration disclosed herein;

FIG. 2 illustrates a flow chart showing the actions required to accomplish the detection method of FIG. 1, in accordance with at least one configuration disclosed herein;

FIG. 3 illustrates a block diagram of the hardware required to sense an orientation and motion of a buoy, generate control commands, and determine a suitable mode of radio operation in accordance with at least one configuration disclosed herein;

FIG. 4 illustrate a system execution flow diagram showing the operations of system to perform the method of FIG. 2 in accordance with at least one configuration disclosed herein;

FIG. 5 illustrates a block diagram for the PNT loop activities described with respect to the system execution flow diagram of FIG. 4;

FIG. 6a illustrates the results of the swell detection method executed during the system loop of FIG. 4 in accordance with at least one configuration disclosed herein;

FIG. 6b illustrates the results of the swell detection method executed during the system loop of FIG. 4 in accordance with at least one configuration disclosed herein;

FIG. 6c illustrates the results of the swell detection method executed during the system loop of FIG. 4 in accordance with at least one configuration disclosed herein;

FIG. 7a illustrates a cross-sectional schematic illustration of a ground vehicle terrain estimation method in accordance with at least one configuration disclosed herein;

FIG. 7b illustrates a cross-sectional schematic illustration of a ground vehicle terrain estimation method in accordance with at least one configuration disclosed herein;

FIG. 8 illustrates a method flow chart showing actions required to perform the method of FIGS. 7a and 7b, in accordance with at least one configuration disclosed herein;

FIG. 9 illustrates a block diagram of the hardware required to sense an orientation and motion of a ground vehicle, generate control commands, and determine a mode of operation of the sensors of the ground vehicle in accordance with at least one configuration disclosed herein; and

FIG. 10 illustrate a PCBA with hardware components identified in the block diagram of FIG. 9 in accordance with at least one configuration disclosed herein.

### DETAILED DESCRIPTION OF THE DISCLOSURE

While this disclosure is susceptible of configuration(s) in many different forms, there is shown in the drawings and described herein in detail a specific configuration(s) with the understanding that the present disclosure is to be considered as an exemplification and is not intended to be limited to the configuration(s) illustrated.

It will be understood that like or analogous elements and/or components, referred to herein, may be identified throughout the drawings by like reference characters. In addition, it will be understood that the drawings are merely schematic representations of the configurations disclosed, and some of the components may have been distorted from actual scale for purposes of pictorial clarity.

At least one configuration of at least one of the PNT modules described can operate across one or more commonly used GNSS waveforms and coding techniques, with a common example being GPS L1, a widely used civilian constellation available worldwide. At least one configuration can operate using alternative PNT resources including timing data and correction factors available from multiple global cellular (e.g., Universal Mobile Telecommunications System (UMTS)/3G/4G among others) bands or through the decentralized Long Range (LoRa) and LoRa Wide-Area Network (LoRaWAN). At least one configuration can operate across the unlicensed and Unlicensed National Information Infrastructure (UNII) bands available to many consumer Radio Frequency (RF) communications devices.

At least one configuration has no access to PNT resources internal to the platform, whether through intentional design eschewing these components or through environmental jamming, damage to infrastructure, or lack of access to infrastructure such as operation underground, at high altitudes, or in remote areas such as the Arctic and South Pacific Oceans. One or more configurations may be provided limited PNT data immediately prior to use, e.g., such as uploading GPS coordinates during deployment above the Arctic Circle for moderately accurate calculation of true North relative to Magnetic North typically while the platform tends to have limited drift from the original deployment location.

Ocean currents can be predicted with moderate accuracy, so time since deployment may be used to determine estimated global position after time of deployment simply based on the estimated passage of time and estimated current and wind conditions. In some configurations, local data on current and wind conditions may be measured by additional sensors available to the platform to aid in the accuracy of global position calculations. In some configurations, regional data on current and wind conditions may be provided by a datalink available to the platform to aid in the accuracy of global position calculations.

In some configurations deployed on airborne platforms such as lighter-than-air ships, weather balloons, and other platforms subject to wind drift, global location can be estimated without PNT resources in a similar manner as those estimated in water. Sensors local to the platform can measure wind magnitude and direction, or remotely secured data can be provided to the platform through a datalink provided by terrestrial, marine, airborne, or space-borne communications platforms.

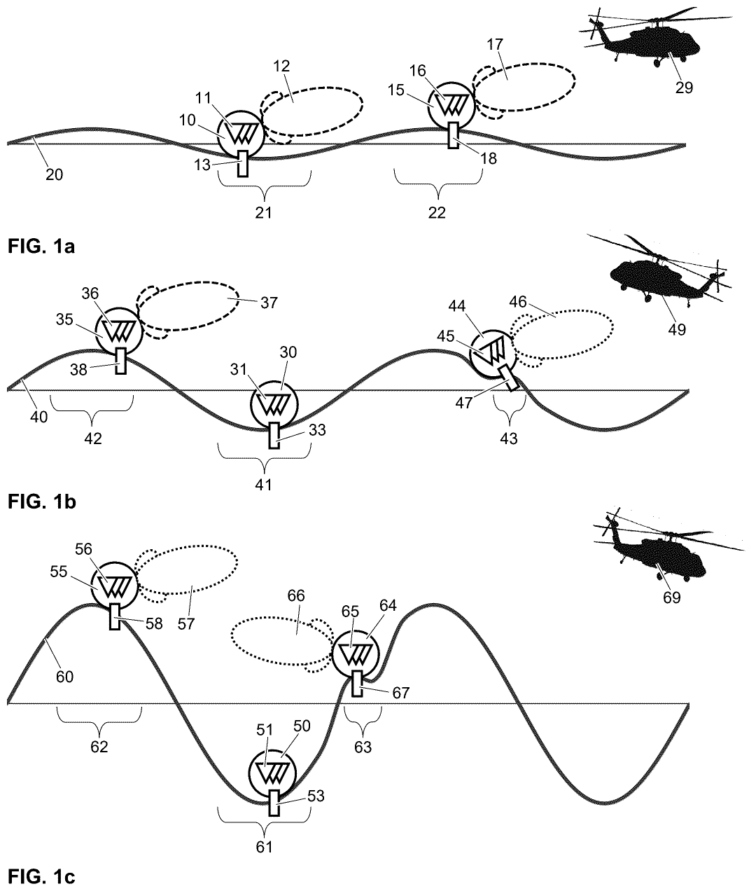

Referring now to the drawings and in particular to FIGS. 1a through 1c, at least one configuration is disclosed to demonstrate operation of a controller for a sensor buoy radio communications phased array subsystem. Three sea states are schematically illustrated to show how a subsystem would operate at enhanced power efficiency and lowered probability of detection and interception (LPD/LPI) by unallied agents operating in the region. Mild swell motion 20 representing smooth ocean conditions and a low sea state (sea state two on the Douglas Sea Scale meaning swell heights 0.1 to 0.5 meters) is provided at FIG. 1a with water vertical displacement relative to local sea level illustrated as a flat line. Moderate swell motion 40 representing commonly encountered ocean conditions at sea state four (swell heights 1.25 to 2.5 meters) is provided in the center of FIG. 1b. Severe swell motion 60 representing very rough ocean conditions at sea state six (swell heights 4-6 meters) is provided at the bottom of FIG. 1c.

A mild trough 21 is shown containing a first mild buoy 10 floating at or near the nadir of the mild swell motion 20. The buoy is configured with a first mild array 11 aimed to the right with a first antenna pattern 12 that is directed towards a mild target 29. The aim direction is controlled by a first mild controller 13 that senses the orientation of the buoy platform and sends control commands to the first mild array 11 to compensate for orientation changes. The first mild controller 13 presently senses the mild swell motion 20 and determines that it is calm enough that the controller has information that the first mild array 11 of the controller is able to maintain direct line of sight to the mild target 29 and therefore selects a radio mode capable of transmitting high data rates.

A mild peak 22 is shown containing a second mild buoy 15 floating physically near the apex of the mild swell motion 20. This buoy is configured with a second mild array 16 aimed to the right with a second antenna pattern 17 that is also directed towards the mild target 29. In a similar manner as with the first mild buoy 10, the aim direction is controlled by an analogous second mild controller 18. Also as with the first mild controller 13, the second mild controller 18 determines that the sea state is calm enough that second mild array 16 is able to maintain direct line of sight to the mild target 29 whether or not the buoy is at a swell apex, and similarly selects a radio mode capable of transmitting high data rates.

A moderate trough 41 is shown containing a first moderate buoy 30 floating at or near the nadir of the moderate swell motion 40. The buoy is configured with a first moderate array 31 with the aim direction determined by a first moderate controller 33 that senses the orientation of the buoy platform and sends control commands to the array. The first moderate controller 33 presently senses the moderate swell motion 40 and determines that the first moderate array 31 is highly unlikely to have direct line of sight to the moderate target 49 and therefore selects to keep the radio silent and accumulates stored data until it is in a better position to communicate.

A moderate peak 42 is shown containing a second moderate buoy 35 floating physically near the apex of the moderate swell motion 40. This buoy is configured with a second moderate array 36 aimed to the right with a moderate antenna pattern 37 that is directed towards a moderate target 49 by a second moderate controller 38. The second moderate controller 38 determines that the second moderate array 36 should be able to maintain direct line of sight to the moderate target 49 now that the buoy is at the moderate peak 42 and selects a radio mode capable of transmitting high data rates.

A moderate local maximum 43 is shown containing a third moderate buoy 44 floating physically at a local high point that is in between the swell apexes of the moderate swell motion 40. This buoy is configured with a third moderate array 45 aimed to the right with a third antenna pattern 46 directed towards the moderate target 49 by a third moderate controller 47. The third moderate controller 47 determines that the third moderate array 46 might have partial line of sight to the moderate target 49 but the third moderate controller also senses that one of the elements is partially submerged (details not illustrated in FIGS. 1a through c) and therefore selects a radio mode capable of transmitting low data rates and turns off the compromised array element so the unit operates as a partially populated phased array with a reduced effective gain (and therefore range).

A severe trough 61 is shown containing a first severe buoy 50 floating at or near the nadir of the severe swell motion 60. The buoy is configured with a first severe array 51 with the aim direction determined by a first severe controller 53 that senses the orientation of the buoy platform and sends control commands to the array. As with the first moderate controller 33, the first severe controller 53 senses the severe swell motion 60 and determines that the first severe array 51 will not have line of sight to the severe target 69 and selects to keep the radio silent and accumulates stored data until in a better position to communicate.

A severe peak 62 is shown containing a second severe buoy 55 floating near the apex of the mod severe swell motion 60. This buoy is configured with a second severe array 56 aimed to the right with a severe antenna pattern 57 that is directed towards a severe target 69 by a second severe controller 58. The second severe controller 58 determines that the second severe array 56 should be able to maintain direct line of sight to the severe target 69 now that the buoy is at the severe peak 62. However, unlike the previous cases, the adverse weather conditions come with expectations of high salt spray and cresting wave scattering of radio frequency energy that would likely compromise high bandwidth transmissions, so the second severe controller 58 selects a low data rate radio mode.

A severe local maximum 63 is shown containing a third severe buoy 64 floating physically at a local high point that is in between the swell apexes of the severe swell motion 60. This buoy is configured with a third severe array 65 aimed back with a third antenna pattern 66 directed towards second severe buoy 55 by a third severe controller 67. The third severe controller 67 determines that the third severe array 65 might have partial line of sight to other buoys in the region, but that there is not a line of sight to the severe target 69. In this example, these buoys have the ability to operate as relays so the desire is that the second severe buoy 55 or some other buoy might be able to relay data pertaining to the third severe buoy 64 data to the severe target 69. Due to the inclement weather, a low data rate radio mode is selected but data is retained in the buffer so the data might be re-sent in full once the buoy reaches an apex some few seconds later.

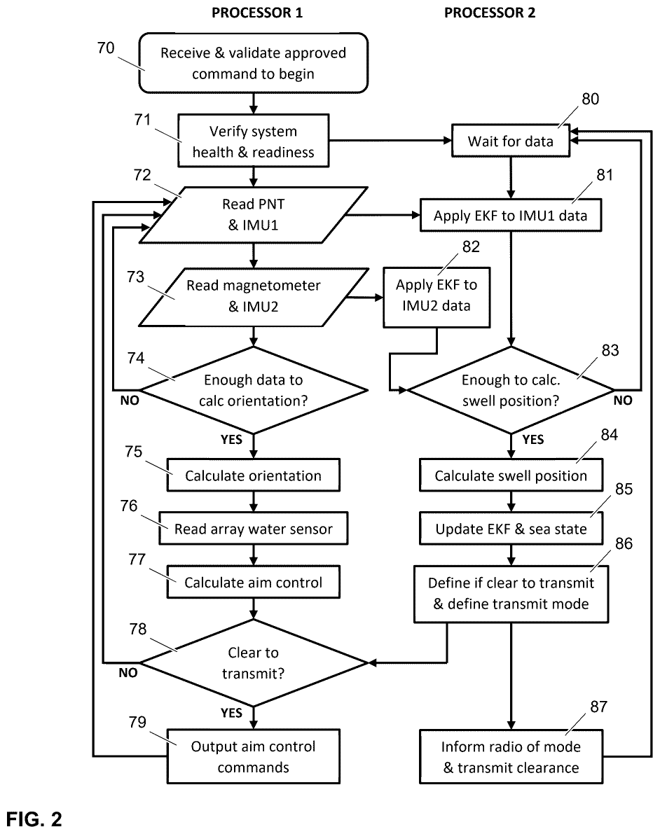

The example at least one configuration of FIGS. 1a through 1c continues with a flow chart of processor activities schematically illustrated in FIG. 2. This flow chart is followed by each of the eight buoys illustrated in FIGS. 1a through c. The illustration separates the activities of at least two processors working together within each buoy, hereinafter referred to as Processor 1 and Processor 2, into two columns (while other configurations are contemplated). The flow chart begins with receive approval start 70 whereupon prior to start at least Processor 1 has been powered on and is ready for receiving commands from an external commanding agent and, additionally, for Processor 1 having the structure configured to approve at least one of the authenticity of the command and the commanding agent. During receive approval start 70, Processor 1 receives a command from an external commanding agent and authenticates the validity of the command and proceeds to the first process.

The first process is to verify system health 71, during which Processor 1 checks system state flags for readiness, ensures system power is ready, and all required hardware elements are powered up and operating. One element of system readiness is for

Processor 1 to determine the direction of intended aim, if any. In at least one configuration, the direction of aim is omnidirectional in azimuth. In at least one configuration, the direction of aim may optionally include a direction of at least one desired null. In at least one configuration the direction of aim is provided as part of the command to begin operation as provided by the external command agent. In at least one configuration the direction of aim is stored in data and retrieved during this action. Once the system is verified as ready for action, Processor 1 informs Processor 2 that Processor 1 may now prepare itself to wait for data 80. Once Processor 2 is started up, Processor 1 moves ahead with the data input gathering actions.

Processor 1 gathers the first data during the read PNT process step 72, whereupon Processor 1 polls the combined PNT and IMU module. The IMU capabilities contained in this module are referred to as IMU1 to differentiate the polling characteristics and data from IMU2 contained within the magnetometer module. Once the data is collected, the data is made available to Processor 2 and Processor 1 is free to move on to collect data from the second module. Note that read PNT process step 72 is a return point for the process flow in at least one configuration of the presently disclosed subject matter so the process is effectively “free running” with updating of position and orientation until communications fail due to power availability or the system calls an end to the activity.

Continuing down the activities for Processor 1 to complete these descriptions before moving on to Processor 2 activities, the process flow moves to gather data from the second IMU sensor. Processor 1 now gathers data from read magnetometer data 73, which includes 3-axis magnetometer magnetic field data and 3-axis IMU2 acceleration data in at least one configuration. In an analogous fashion as with the IMU1 data, the IMU2 data is made available to Processor 2, and Processor 1 is now free to review and consider the data collected thus far.

Processor 1 examines the data from the PNT and IMU1 module along with the magnetometer and IMU2 at the enough data to determine 74 decision action. If the data quantity or quality (or both) are insufficient to determine the orientation of the sensor, then the process flow proceeds back to the read PNT data 72 process step. If the data quantity and quality are sufficient to determine the orientation of the sensor, then Processor 1 proceeds ahead to determine orientation 75. In this process, the data from the PNT and IMU1 module and the magnetometer and IMU2 module is used to determine two vectors relative to the sensor orientations of the two modules.

The first vector determined is the direction of gravity, which is readily determined from IMU1 acceleration data and IMU2 acceleration data in the three cardinal directions based on a frame of reference for each sensor module. In at least one configuration, the calculations are performed on IMU1 acceleration data and IMU2 acceleration data independently to construct two gravity vectors. In at least one configuration, at least two gravity vectors are averaged together to create a single gravity vector representing an estimate of the true (global) gravity vector.

The second vector determined is the direction of Magnetic North of the Earth, which is readily determined from 3-axis magnetometer data in the three cardinal directions based on the frame of reference of the magnetometer module. In at least one configuration, the combination of one gravity vector and one Magnetic North vector is sufficient to estimate the orientation of the sensor platform with an accuracy that is calculable based on the noise level and accuracy level of the sensor modules interrogated. In at least one configuration, the determined estimated gravity vector will be within 5 degrees of the true gravity vector. In at least one configuration, the calculated estimated North vector will be within 5 degrees of the true Magnetic North vector.

Now that Processor 1 has estimated gravity and North vectors, Processor 1 determines the orientation of the sensor modules and, therefore, the antenna array relative to these vectors. Multiple methods of mathematical operations can accomplish this process step, as will be understood by one of ordinary skill in the art of vector mathematics or linear algebra.

Now that Processor 1 has determined the orientation of the antenna array, Processor 1 is now ready to determine if the array itself is physically and electrically clear of water and therefore free to operate at radio frequency without undue influence of the relatively high dielectric and loss properties of water. Processor 1 takes the process step to read array water sensor 76 to determine if each of the elements in the array are clear. If the water sensor determines that any element in the array is in proximity to water, then such an element will be removed from future consideration for calculation of array aim control and will not participate in either transmit or receive operations.

In at least one configuration, Processor 1 at this stage of the flow diagram has a definition of the present orientation and of the intended array aim location. In at least one configuration the calculation of aim control includes a separate process step to retrieve at least one aim target from memory. In at least one configuration the calculation of aim control includes the retrieval of at least one mode definition from memory. With the available information, Processor 1 is ready to perform the determine aim control 77 action. In at least one configuration, Processor 1 determines the difference between the preferred aim direction and the present orientation and uses this difference to define a local array aim direction. In at least one configuration, Processor 1 converts a local array aim direction into a set of control commands configured to drive a phased array. In at least one configuration, a set of control commands configured to drive a phased array require a command conversion device to translate a command into digitally selected phase state settings. In at least one configuration, Processor 1 converts a local array aim direction into a set of control commands configured to drive at least one mechanical actuator. In at least one configuration, the mechanical actuator to be driven includes at least one of an azimuthal (pan) and an elevation (tilt) actuator. In at least one configuration, Processor 1 converts a local aim direction into a set of phase data used for digital correction of baseband data. In at least one configuration, a set of phase data used for digital correction of baseband data is used for received data alignment prior to summation. In at least one configuration, a set of phase data used for digital correction of baseband data is used for upconversion and transmission for constructive interference in a phased array.

Once aim control calculations have been prepared, Processor 1 proceeds to address whether or not the subsystem is clear to transmit 78. In this action, Processor 1 requires authority from Processor 2 to permit the transmission of aim control commands. If Processor 1 is not clear to transmit 78 then the processor reverts back to read PNT data 72. If Processor 1 is clear to transmit 78 then Processor 1 will output aim control commands 79 by way of at least one communications method. In at least one configuration, one communications method is by a wired communications protocol to a connector interface, said connector being subsequently attached to a radio frequency front end (RFFE) control board capable of receiving a wired communications protocol. In at least one configuration, a wired communications protocol is translated by a complex programmable logic device located on an RFFE into phased array component control signals. In at least one configuration, one communications method is by wired communication protocol to a pan-tilt-zoom control board. In at least one configuration, one communications method is by a wireless radio transmission having a waveform and data in compliance with at least one wireless communications standard protocol.

Once the aim control commands have been transmitted, in at least one configuration Processor 1 reverts back to read PNT data 72. In at least one configuration, Processor 1 will check a system status flag first to determine if additional control is still needed and, if not, will exit the process flow diagram.

The process flow diagram example of FIG. 2 proceeds to describe the actions undertaken and questions addressed by Processor 2 in parallel with the previously aforementioned activities of Processor 1. At the start of Processor 2 activities is the process to wait for data 80. In this process, Processor 2 is waiting for a specific flag to be set by Processor 1 which is used to acknowledge the completion of the read PNT data 72 step.

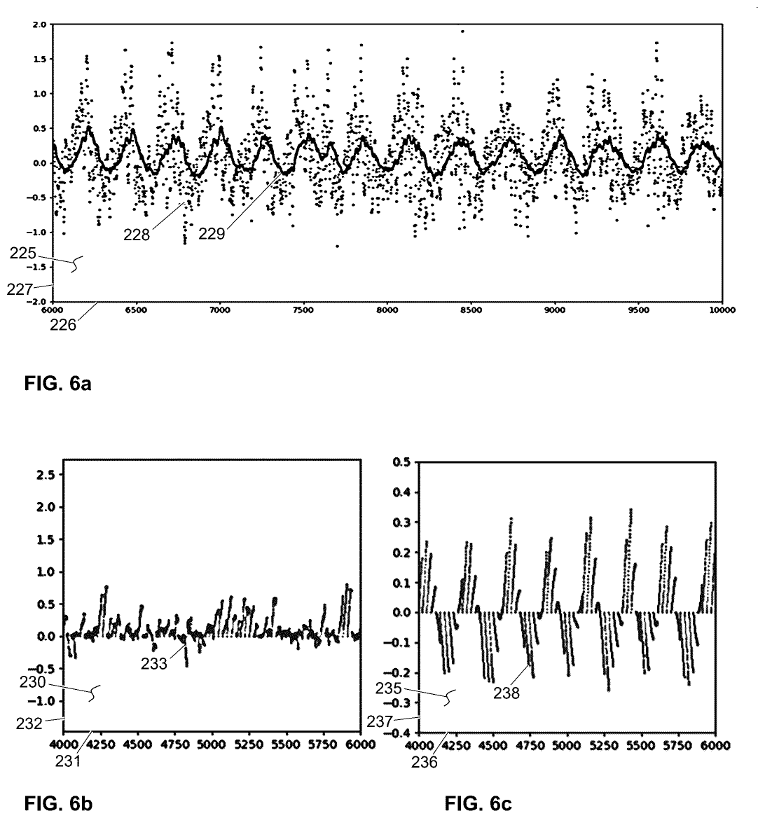

When the read PNT data 72 flag is noted as being set, Processor 2 proceeds to apply the mathematical process of an Extended Kalman Filter (EKF) to the data collected from IMU1 in the apply an EKF to IMU1 81 process. In this process, the data from IMU1 is modified by Processor 2 in accordance with an EKF set to remove the noise from the accelerometer data from each of the three cardinal axes relative to the orientation of the sensor. The process of the EKF and effects on the data are described in more detail in the detailed description of FIGS. 6a through 6c. The processed data is fed to a decision point for further analysis.

After servicing the data from IMU1, Processor 2 moves on to apply an EKF to IMU2 82, where an analogous process is used to remove the noise from the data of IMU2. In this process, an EKF is used to process the data from the three cardinal axes of acceleration of IMU2, and the processed data is fed to a decision point for further analysis. In at least one configuration, the EKF used for IMU1 and IMU2 data sets have different settings as the physical hardware and noise characteristics of IMU1 and IMU2 are different.

Once data from IMU1 and IMU2 have been filtered, Processor 2 asks if there is enough to determine swell 83 as a significant decision. In this decision action, Processor 2 makes the determination of whether or not enough data has been collected to ascertain what the size of the swells relative to troughs are, and whether or not enough data has been collected to determine where in a trough or on a swell the buoy array is physically located. In at least one configuration the answer is generally related to the total amount of data collected to date since the start of the deployment of the buoy and the answer will be “yes” once data has been collected for at least thirty seconds. In at least one other configuration, the answer is yes once data has been collected for at least two minutes to first characterize the swell to trough average height differential for a minimum of six swells.

Once sufficient data has been collected to make a determination of the physical position of the buoy relative to troughs and swells, Processor 2 progresses to the determine swell position 84 process. In this process, the filtered data from at least one of IMU1 and IMU2 is integrated over time to create a velocity vector. In at least one configuration, the velocity vector is determined for velocity in the global vertical (z) direction relative to (aligned with) the true gravity vector. The method of calculating vertical velocity and detecting position relative to a swell or trough is further described by illustrated example in the detailed description of FIGS. 6a through 6c. In at least one configuration, the result of the determine swell position 84 process includes the estimation of the physical position of the buoy relative to at least one of the trough nadir and the swell apex.

In at least one configuration of the presently disclosed subject matter, the filter characteristics used to reduce noise in the IMU1 and IMU2 data will be updated during operation. In the process flow illustrated in FIG. 2, Processor 2 is shown performing the update EKF process step 85 where the factors used in the EKF used to process the data from each of IMU1 and IMU2 are each themselves updated. In this manner, the EKFs will be continuously updated to filter data appropriately even under conditions of progressively worsening drift or weather conditions impacting sensor performance.

In at least one configuration, the update EKF process step 85 in whole or in part comprises an update to the global environment sea state conditions experienced by the buoy. In at least one configuration, the global environment sea state condition is updated slowly over time using stored historical data. In at least one configuration, this update occurs every ten minutes to match the approximate time frame of the rate of severe local weather change. It is envisioned that a wide variety of update rates can be used within the expected set of configurations in accordance with the presently disclosed subject matter, and a set of update rates might range from between every second to every four hours depending on the type of data desired in a specific implementation and deployment. In at least one other configuration, the relative sea state or other external environmental characteristics are neither measured nor determined.

In at least one configuration, Processor 2 is clear to proceed to the clear to transmit 86 process step. In this process step, Processor 2 will determine if the position of the buoy relative to at least one of the trough nadir and the swell apex is in an appropriate position for transmission and reception using at least one antenna in the antenna array. In at least one configuration, the relative sea state conditions factor into this calculation, as transmission at or near a swell apex is not required if water conditions are calm. In at least one configuration, the implementation height of the antenna array from the nominal water surface factors into this calculation, as a deployment configuration having taller antennas can operate over larger periods of time relative to the swell apex than other configurations having smaller antennas that may only be able to transmit at or near the very swell apex itself. In at least one configuration, a clear to transmit 86 calculation dynamically factors in the global nominal sea state, the proximity of the buoy to swell apex, and the nominal deployed antenna height to determine whether or not the buoy is, in fact, clear to transmit.

During the clear to transmit 86 process, Processor 2 determines what mode of transmission or reception shall be permitted. As with the process to determine eligibility to transmit or receive, this calculation for allowed mode may also consider at least one of the nominal sea state, the buoy to swell apex, and the nominal deployed antenna height to determine which mode should be selected. In at least one configuration, the physical location of the buoy relative to swell apex is used to determine if a shorter-range relay mode should be used instead of a mode attempting to reach the original target, such as in the example of FIG. 1c where the third severe controller 67 selected an alternative mode to communicate with a nearby second severe buoy 55 instead of towards the severe target 69.

Whatever the results of these calculations, the decision to clear and the recommended mode of operation are communicated to Processor 1. Separately, the decision to clear and the recommended mode of operation are also communicated to the buoy VHF/UHF radio in the inform radio 87 action. Once the radio has been informed, Processor 2 reverts back to wait for data 80 so the process continues. In at least one configuration, a system status flag is checked first to determine if additional control calculations are still needed and, if not, Processor 2 will exit the process flow diagram.

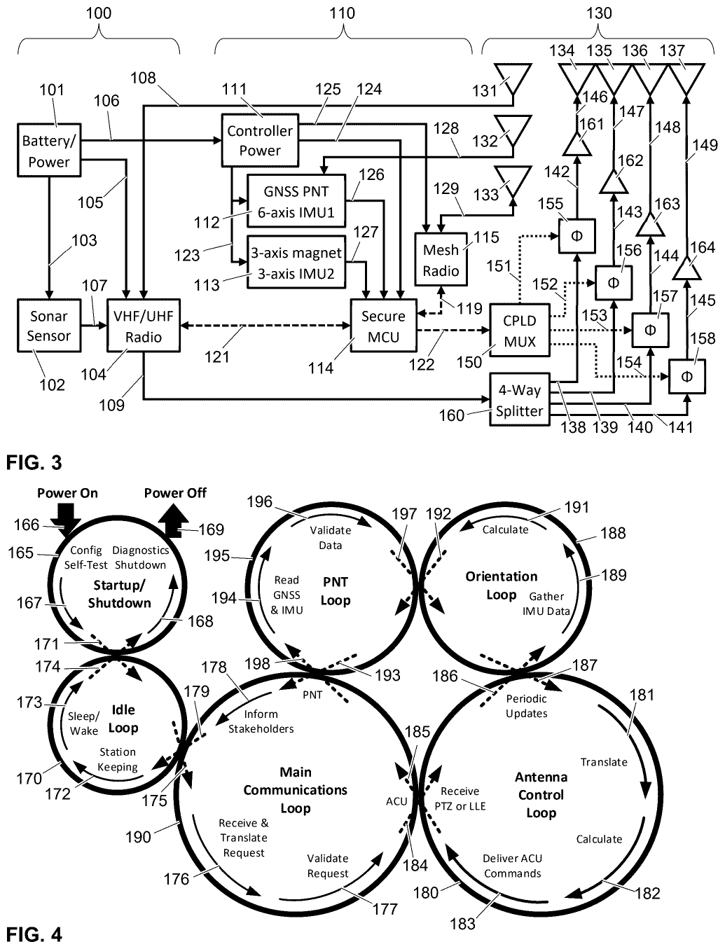

At least one configuration of hardware suitable for supporting the process flow chart of FIG. 2 is provided in the hardware block diagram of FIG. 3. A buoy payload region 100 is connected to a controller region 110 which is connected to an antenna array 130. A plurality of connectivity is described herein to describe how these circuit and component elements interact to provide the capability illustrated in FIGS. 1a through 1c.

In at least one configuration, a buoy battery 101 provides power to the systems described herein. The buoy battery 101 provides controller power 106 to the controller power circuit 111, provides radio power 105 to the VHF/UHF radio 104, and provides sonar power 103 to the sonar sensor 102. The buoy battery 101 also provides power to the antenna array 130 elements but these connections are not illustrated for the sake of brevity and clarity of the diagram and are therefore left to the imagination of the reviewer and to the workload of the designer seeking to implement one or more aspects of the disclosed subject matter.

In at least one configuration, the sonar sensor 102 provides sonar data 107 to the VHF/UHF radio 104. The intended role of the VHF/UHF radio 104 is to upconvert the sonar data 107 into a data uplink signal 109 that ultimately is sent to a receiving target such as the severe target 69 of FIG. 1c. The VHF/UHF radio 104 is also capable of receiving commands from approved and authorized external agents by way of a downlink signal 108. In at least one configuration, the data uplink signal 109 and the downlink signal 108 are radio frequency signals.

Radio frequency signals are known to propagate through transmission media with a frequency range typically defined as being between 20 kHz and 300 GHz. At lower frequencies, signals can include audio frequencies where these frequencies transmit power through molecular interaction rather than through photons. At higher frequencies, signals can include optical signals such as infrared through ultraviolet frequencies, and power is still transmitted through photons and may be collimated for improved range. In at least one configuration, the downlink signal 108 is a signal in the UHF band, defined as between 300 MHz and 3 GHz. In at least one other configuration, the downlink signal 108 is a signal in the VHF band, defined as between 30 MHz and 300 MHz. In at least one configuration, the data uplink signal is a signal in the VHF band.

Turning to the controller region 110, the controller power circuit 111 provides sensor power 123 to the PNT IMU1 module 112 and magnetometer IMU2 module 113. The controller power circuit also provides MCU power 124 to the secure MCU 114 which in at least one configuration is comprised of multiple direct current voltage levels and power lines ranging from between +1.2V and +3.3V in voltage level as referenced to battery return (local ground). The controller power circuit 111 also provides mesh radio power 125 to the on-board mesh radio 115. Voltage and current levels for power electronics, including power conversion, electromagnetic emission generation, electromagnetic sensitivity, noise control, safety circuitry, wire selection, and PCBA trace and power plane design are all well known to one of skill in the art of electronics.

The PNT IMU1 module 112 is the sensor module that provides inertial measurement data used to determine both orientation relative to gravity and vertical position relative to swells. The PNT IMU1 data 126 is seen to flow into Secure MCU 114 when requested. This module also contains an RF receiver circuit that translates the GNSS signal 128 into PNT data. In at least one configuration, the GNSS signal 128 is a combination of received signals from multiple satellites of each of multiple constellations of satellites. The PNT IMU1 module decodes these received signals and provides an approximate global location for the buoy. Unfortunately, GNSS transmissions are easy to jam or spoof with false locations, and therefore should not be relied upon in contested environments. Also, commercial low-cost GNSS receivers are often unable to provide accurate global z-height measurements. Height can vary by as much as 20 meters during typical operations even when working properly without obstruction. If attempting to measure height to within 0.5 meters relative to swell apex, for example, a GNSS drift or variance of 20 meters is not useful for this purpose.

The magnetometer IMU2 module 112 is the sensor module that provides magnetic data used to determine orientation relative to Magnetic North of the Earth as well as inertial measurement data used to determine both orientation relative to gravity as well as vertical position relative to swells. The magnetometer IMU2 data 127 is seen to flow into Secure MCU 114 when requested.

The secure MCU 114 is the primary engine for the calculations and decision making activities of at least one configuration of the presently disclosed subject matter. In at least one configuration where the hardware of FIG. 3 performs the process flow chart of FIG. 2, the secure MCU 114 itself contains both Processor 1 and Processor 2 with duties as described in FIG. 2, and the two processors share a commonly accessible memory bank to readily share data and set and read flags between them.

A control datalink 121 is configured between the VHF/UHF radio 104 and the secure MCU 114. In at least one configuration, the control datalink 121 is comprised of a serial data communications connection. In at least one configuration, the control datalink 121 is a communications connection based on the Universal Serial Bus (USB) standard. In at least one configuration, the control datalink is comprised of a parallel communications connection.

A mesh radio datalink 119 provides a structure configured for communication between the secure MCU 114 and authorized external agents by transmitting and receiving signals through the mesh radio 115. The mesh radio signal 129 is an RF signal connected through to the omnidirectional element in the antenna array. Separately, by structure configured for the control datalink 121, the VHF/UHF radio 104 is also able to operate the mesh radio 115 through the mesh radio datalink 119 if a command to the secure MCU 114 is given to affect this purpose. Data from external agents can be both sent and received through the mesh radio instead of through the VHF/UHF radio 104 downlink signal 108 and uplink signal 109, providing an alternative method for wireless communication.

An array control signal 122 is generated by the secure MCU 114 and sent to a multiplexing circuit in the antenna array 130 to control the phased array. In at least one configuration, the array control signal 122 represents a wired path (including connectors) between the controller region 110 and the antenna array 130 as a communications method used to transmit the results of the output aim control commands 79 process step from the example of FIG. 2.

In at least one configuration, the antenna array 130 is comprised of seven different antennas in an arrangement that enables each antenna to function without undue influence from proximity to each other rendering any element inoperable. Three antennas are configured as omnidirectional antennas and therefore do not have directional control managed by the controller section 110. The other four antennas are configured as an uplink phased array, which provides longer range for the limited power available to the buoy, a feature of phased arrays known to one of ordinary skill in the art of wireless communication systems.

In at least one configuration the downlink antenna 131 provides the downlink signal 108 and is omnidirectional because the transmissions needed to be heard from the external agents have a very high signal strength and very low bandwidth and do not therefore benefit from the added complexity and capability of a phased array.

In at least one configuration, the GNSS antenna 132 provides the GNSS signal 128 to the PNT IMU1 module 112 and is omnidirectional because the satellite signals received come from many different directions simultaneously. Fortunately, the PNT IMU1 module 112 has a very high sensitivity, and so the higher gain of an array is not required in most maritime environments where there is no foliage or man-made structures to block satellite signals.

In at least one configuration, the mesh radio antenna 133 provides the mesh radio signal 129 to the mesh radio 115. In at least one configuration, the mesh radio antenna 133 is tuned to operate at one or more frequency bands in the UHF range.

The uplink signal 109 is provided to a four-way splitter 160 which splits the uplink signal 109 into four separate signals, each to be separately modified and transmitted, a first initial signal 138, a second initial signal 139, a third initial signal 140, and a fourth initial signal 141 each ready for modification based on their own individual control signals.

The combined array control signal 122 from the secure MCU 114 is sent to the CPLD MUX 150 which multiplexes a combined signal into four separate individual combinations of control signals. A first control signal 151 is sent to a first phase shifter 155 as well as to the first amplifier 151 (connection not shown). A second control signal 152 is similarly sent to a second phase shifter 156 as well as second amplifier 152. As envisioned, a third control signal 153 is sent to a third phase shifter 157 and third amplifier 153, and a fourth control signal 154 is sent to a fourth phase shifter 158 and fourth amplifier 154.

The first phase shifter 155 changes the phase of the first initial signal 138 in accordance with the calculation made by the secure MCU such that the final transmitted signals between all four antenna elements in the phased array will constructively interfere and have an increased power level and range. The resulting signal is a first phased signal 142 sent to the first amplifier 161. Assuming the first control signal 151 permits the first amplifier 161 to amplify, then the first amplified signal 146 will be sent to the first array element 134 for transmission.

It is contemplated that in certain modes of operation, the first control signal 151 will not permit the first amplifier 161 to amplify the first phased signal 142. An example of at least one mode of operation would be if a sensor (not shown in FIG. 3) detects that the first array element 134 is in contact with seawater, then the amplifier would not be allowed to amplify the signal, as this could engage a dangerous mismatch reflection condition known to one of ordinary skill in the art of radio frequency power electronics that might damage or destroy the amplifier or other element.

To the end purpose of creating a phased array transmission, the second phase shifter 156 changes the phase of the second initial signal 139 to result in a second phased signal 143 sent to the second amplifier 162. Assuming the second control signal 152 permits the second amplifier 162 to amplify, then the second amplified signal 147 will be sent to the second array element 135 for transmission.

In a similar manner and to the same end purpose, the third phase shifter 157 changes the phase of the third initial signal 140 to result in a third phased signal 144 sent to the third amplifier 163 to create a third amplified signal 148 sent to the third array element 136 for transmission.

To complete the elements engaged in the phased array transmission, the fourth phase shifter 158 changes the phase of the fourth initial signal 141 to create a fourth phased signal 145 which is itself sent to the fourth amplifier 164 to create a fourth amplified signal 149 routed to the fourth array element 137.

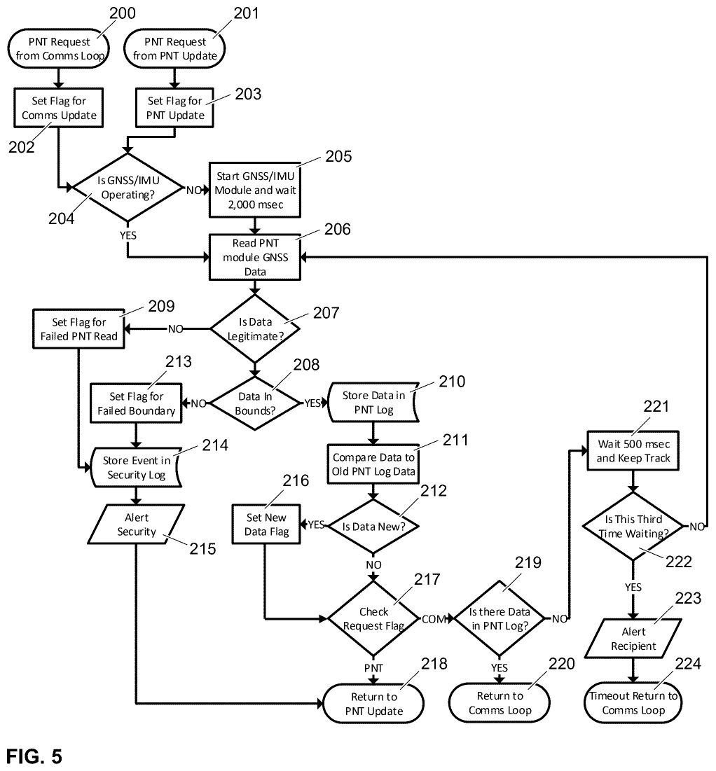

The system needed to drive the hardware of FIG. 3 in accordance with the actions described in the flow chart of FIG. 2 can be developed and implemented in many ways. For at least one configuration, the system activity loops for Processor 1 are described in FIG. 4. Each of these system loops is described below in terms of the actions that occur and how these actions correlate to the process flow diagram of FIG. 2. In at least one configuration, the same system loop diagram describes the activity of Processor 1 for each of the buoys operating in a specific theater that incorporate the presently disclosed subject matter. It is noted that a specific implementation of system methods is not presented herein, although a detailed methods block diagram for the PNT loop activities is provided in FIG. 5 by way of example and could be readily translated into system methods suitable for operation on the MCU by any capable programmer using their preferred coding language insofar as that preferred language is supported by that MCU.

The first system loop module is the startup/shutdown loop 165 which is entered when the system power on 166 process step is undertaken. Powering the system is usually performed by permitting voltage power inputs to each achieve the minimum acceptable levels for the MCU module containing Processor 1 to power up. Once these voltage levels are achieved, and any required reset process step (if present) is taken, then the system power on 166 process step is assumed to have occurred.

The system will then enter the startup/shutdown loop 165 where basic station-keeping process steps are performed. After powering up, the system will perform a configuration/self-test process step 167 where at least one configuration file will be read to inform Processor 1 about the settings is the system is expected to operate with for this period. Once the configuration file has been read, the system will perform at least one self-test operation to ensure that the system is ready to operate. If the self-test is passed, then the system will perform a startup-idle transition 171. If the self-test is failed, then the startup/shutdown loop 165 will continue to spin without exiting. In at least one configuration, a failed self-test will require performing a repeat of the config/self-test process step up to three additional times before setting an error methods system flag (not illustrated as part of the config/self-test process step 167 or, indeed, explicitly as part of any process step illustrated in FIG. 4) and subsequently moving into the diagnostics/shutdown process step 168. In at least one other configuration, a failed self-test will immediately set an error methods system flag and move into the diagnostics/shutdown process step 168. Other configurations with other numbers of attempts to pass the config/self-test process step 167 are additionally envisioned as fully encompassing the presently disclosed subject matter without divergence.

In the diagnostics/shutdown process step 168, the system assesses the health of the hardware and system status along with any error methods that have been generated. In at least one configuration, if the diagnostics/shutdown process step 168 was entered as a result of a failure to pass the self-test after powering on, then after diagnostic analysis, the loop will return back to the config/self-test process step 167 for another attempt. In at least one configuration, once the diagnostics portion of the diagnostics/shutdown process step 168 is completed, the system prepares to power down all devices the system controls in a prescribed manner and order, preferably ending with Processor 1 entering a sleep mode ready to be restarted if so triggered or powered off completely depending on the system flags set. If the system successfully performed the startup-idle transition 171, the

system will enter the idle loop 170. In this loop, the system typically monitors the health of the hardware and system in a station keeping process step 172 and stays alert for activity that requires action. Most of the time in this loop is spent waiting at the sleep/wake process step 173, which is the antithesis of a process step, pausing relatively briefly to re-perform the station keeping process step 172 and return to idle.

One activity requiring action is the detection of a power down event, which in at least one configuration is the detection of a drop in voltage of at least one power rail. If this occurs, the system exits the sleep/wake process step immediately, sets a flag defining an imminent shutdown, and enters the idle-shutdown transition 174. Based on the system flags set, the diagnostics/shutdown process step 168 may perform an abbreviated set of activities and prepare for a safe powering down of all hardware. A similar sequence would be performed if the command to power down were instead provided by an authorized external agent. In at least one configuration, the system flags designating an impending shutdown event will be different than with the imminent shutdown event so the diagnostics/shutdown process step 168 will instead perform a full shutdown sequence instead of an emergency shutdown sequence.

In at least one configuration, another activity requiring the system to exit the sleep/wake process step 173 is the passage of time. When exiting the sleep/wake process step 173, the system enters the idle-comms transition 175. In at least one configuration, the system is instructed to re-measure the current position every minute regardless of whether or not any specific command has been given, any data is being collected, or any data is being transmitted. In at least one configuration, the system is instructed to gather data from both the PNT IMU1 module and the magnetometer IMU2 module every five minutes to ensure data collection and analysis is properly working. In at least one configuration, the system is instructed to wait a different amount of time based on at least one of historical activity, mission configuration settings, and system flags.

In at least one configuration, another activity requiring the system to exit the sleep/wake process step 173 is the detection of an incoming command. When an incoming command is detected, but before the command is known, and if no imminent or impending shutdown flag is present, then the system enters the idle-comms transition 175. This moves the system into the main communications loop 190 ready to receive, translate, and validate incoming commands or requests.

In the main communications loop 190, the system first determines if there is a communications request ready for reception. the system executes the receive request process step 176 and waits a period to see if a request is received. In at least one configuration, the period of time the system waits is approximately ten (10) msec. In at least one configuration, the period of time the system waits is dependent on at least one of historical activity, mission configuration settings, and system flags. If received, the system will translate the request so as to determine the sender and the nature of the request.

If successfully translated, the system enters the validate request process step 177. If not successfully received and translated, the system skips the validate request process step 177. In at least one configuration, the translation of the request includes the act of decryption based on at least one decryption key. In at least one configuration, the validation of the request includes the use of authentication system. In at least one configuration, the validation of the request includes verifying the radio frequency waveform characteristics of the incoming request matched expectations for at least one authorized external agent.

If the validate request process step 177 was successful, and the request requires action in a different loop, then the system will move to the appropriate transition activity. If the valid request requires antenna control (including turning amplifiers on or off) or a request for orientation information, the system will proceed to the comms-control transition 184. If the valid request requires gathering PNT information, the system will proceed to the comms-PNT transition 198. If the valid request is to return to idle, perform diagnostics, update system, or to shut down, then the system will proceed to the comms-idle transition 179.

If the validate request process step 177 was unsuccessful, or if the successfully validated request involves communicating with at least one external agent, then the system will continue proceeding around the main communications loop 190 to the inform stakeholders process step 178. In this process step, the system will gather the data required and send the data along through at least one structure configured for communication. In at least one configuration this process step includes providing data and radio control commands. In at least one configuration this process step includes sending data using a wired communications protocol to an electrically connected external agent.

Continuing the description of the system loops by way of example, consider that the system has been instructed to begin controlling the antenna as the main buoy radio seeks to start transmitting sonar data. In this example, the antenna control loop 180 is entered by way of the comms-control transition 184. A configuration flag has been set that the antenna array type is a phased array with four elements using a CPLD multiplexer, and that the target aim point is available in latitude-longitude-elevation (LLE) format. With this set of conditions, the antenna control loop 180 system has the information that the orientation and global position of the buoy is to be known before control commands can be generated, so the control-orientation transition 186 over to the orientation loop 188 is undertaken before any antenna control activities like translation and calculation are performed.

To continue the example, the system enters the orientation loop 188 where the system first gathers the data available from the magnetometer/IMU2 module in the gather IMU data process step 189. The data is verified to be correct and at which time the Magnetic North vector and gravity vector are determined in the determine process step 191. Not shown is that Processor 1 also stores the IMU2 accelerometer data for filtering and swell detection processing by Processor 2, actions which occur in an analogous system loop for Processor 2 which is not illustrated in the presently disclosed subject matter but that follows similar concepts as described herein to accomplish the process flow chart processes shown for Processor 2 in FIG. 2.

When the calculations are complete, the system next needs to gather the PNT and IMU1 data from a different module, so the system takes the orientation-PNT transition 192 to enter the PNT loop 195. Note that the order of operation of collecting the data from the PNT/IMU1 module and the magnetometer/IMU2 module tends not to be significant as the order is based on which system loop was entered. The subsequent activity flags can then be performed on the data that was gathered. This provides the greatest flexibility for the system to enter and exit system loops in a deterministic manner while minimizing overhead. In at least one configuration this arrangement also permits the use of different speeds of data collection between the orientation loop 188 and the PNT loop 195.

Continuing the previous example, the system has entered the PNT loop 195 by way of the orientation-PNT transition 192 instead of by way of the comms-PNT transition 198. Based on the system flags set, the system has the information that the system is to return to the antenna control loop 180 to service the valid request and therefore returns by way of the PNT-orientation transition 197 instead of kicking back out to the comms loop 190 by way of the PNT-comms transition 193.

Inside the PNT loop 195, the system reads the location and acceleration data provided by the GNSS receiver and integrated IMU1 in the read GNSS process step 194. In at least one configuration, this data includes the present location as estimated by the PNT module using a combination of at least one GNSS constellation and the internal IMU measurements, as well as the present data of acceleration in the three cardinal axes relative to sensor module orientation as well as the present data of axial acceleration around those cardinal axes.

Once data is received, the system performs the validate data process step 196 to ensure the data appears present and appropriate. If the GNSS data was not received, then the system will set a flag that GNSS data was not received. If the GNSS data does not appear valid within the constraints supplied according to the configuration, then the system will set a flag that GNSS data is not valid. Similar actions and flags are set based on the presence and validity of the six items of IMU1 data. In at least one configuration, if the data does not exist for either GNSS or IMU1, then the system will perform a second pass around the PNT loop and attempt to read GNSS process step 194 and validate data 196 again. In at least one configuration, the system will ignore data not collected or invalid, and take the PNT-orientation transition 197 to return to the orientation loop 188.

If the previously held orientation loop data appears both present and valid, including ensuring that an extended period of time has not passed, then the system does not need to re-gather orientation sensor data and will take the orientation-control transition 187 to return to the antenna control loop 180. If the system determines new orientation data is required, or if the system did not gather the data the first time the system was in this loop, then the system will proceed around the orientation loop to gather IMU data process step 189 and determine orientation 191 returning to the orientation-control transition 187 when complete. In at least one configuration, if no valid data has been gathered during the time in the orientation loop 188 and PNT loop 195, the system will continue both interrogations again. In at least one configuration, the system will continue to interrogate at least one of the loops ten times before timing out, setting an error flag, and exiting by way of the PNT- comms transition 193 to the main communications loop 190 to inform stakeholders 178 there is a sensor data collection problem.

Continuing the previous example where data has been collected successfully, the system has returned to the antenna control loop 180. Now prepared with one or more sets of data, the system turns to the functions of translating available location data into an aim vector relative to the orientation vector in the translate data process step 181. During the translate process step 181, if no recent valid GNSS data is available, in at least one configuration the system will use an estimated position based on previous trusted data. In at least one configuration the previous trusted data on position location is adjusted based on time since the trusted data was available. In at least one configuration the previous trusted data on position location is adjusted based on ocean current conditions since the trusted data was available. In at least one configuration the ocean current conditions since the trusted data was available are based on historical ocean current data for the region of deployment. In at least one configuration, at the end of the translate process step 181, the difference between the estimated position of the buoy and the desired aim direction has been determined.

Continuing the example, now that the system has translated the intended aim direction and previously determined the current orientation, the system moves on to the determine commands process step 182 of the antenna control loop. The vector difference between the present orientation and the desired aim direction is determined and antenna control commands are generated to eliminate this difference. In at least one configuration, this process step is performed using vector matrix math followed by referencing a control command lookup table for the desired commands.

Once the antenna control commands have been created, the system moves to the delivery ACU commands process step 183 whereupon the antenna control commands are delivered by a structure configured for communications. In at least one configuration this process step includes providing data and radio control commands. In at least one configuration this process step includes sending data using a wired communications protocol to an electrically connected actuator controller circuit. In at least one configuration this process step includes sending commands to turn on the power amplifiers for at least one antenna element out of the array. In at least one configuration the commands for the power amplifiers include at least one command to set the output power level of at least one amplifier to a specified level.

Once the commands have been delivered, the system is able to exit the antenna control loop 180 by structure configured for the control-comms transition 185 and return to the main communications loop 190. In accordance with the configuration for this mission, the system then moves to the inform stakeholders 178 process step to let the main buoy radio have information that the antenna array has been aimed, the appropriate amplifiers are on, and that Processor 1 is ready to receive a new command if one is ready, to go to the idle loop 170 for a period of time, or to return to the PNT loop 195, orientation loop 188, and antenna control loop 180 to maintain aim depending on the configuration settings. In at least one configuration the system will transition to the idle loop 170 for twenty milliseconds before returning to the main activity loops to sample data and update antenna controls again.

The example of FIGS. 1-4 continues with a detailed description of a single system loop to provide greater insight into the system activity portion. The PNT loop 195 is used as an example for additional detail as the PTN loop is among one of the relatively complex modules out of the system loops in at least one configuration illustrated by FIG. 4.

Specifically, a detailed pseudo methods block diagram for the PNT loop activities is provided in FIG. 5 as an example of a sample configuration of the PNT loop of the presently disclosed subject matter. This process step represents the process flow diagram process step read PNT & IMU1 72 of FIG. 2. In at least one configuration, a nearly identical version of this methods block diagram would be used to represent the process flow diagram process step read magnetometer & IMU2 73.

The methods block diagram is readily translated into system methods by one of ordinary skill in the art of programming utilizing any one of a number of different coding languages. In at least one configuration, a programmer can utilize the C language as methods “on bare metal” meaning that no operating system is installed in MCU Processor 1, in one such configuration.

The PNT loop 195 of FIG. 4 is entered in one of two ways, either from the comms-PNT transition 198 or from the orientation-PNT transition 192. These two transitions provide two starting points for the coding block diagram of FIG. 5, the comms loop start 200 and the PNT update start 201, respectively. If starting with the comms loop start 200, the system first sets the comms update flag 202 and proceeds to check if the GNSS/IMU1 module is powered and communicating in the GNSS operating decision 204. If starting with the PNT update start, the system instead sets the PNT update flag 203 and proceeds to the GNSS operating decision 204.

If the GNSS module does not respond to communications requests, a signal is sent to power up or reset the module in the start GNSS process 205. In the start GNSS process 205, the GNSS/IMU1 module is powered up if not already powered up, and then reset. The system then waits 2,000 msec (two seconds) for the module to boot and begin gathering GNSS data. After waiting, the system will poll the module again to determine if there is a response to communications attempts. In at least once configuration, the system will continue to restart and re-poll the GNSS module a total of ten (10) times before timing out, setting an error methods flag, and returning to the PNT-comms transition 193 to inform stakeholders of the error as previously described.

Once the GNSS module responds to communications requests, the next process is to read PNT data 206. In the read PNT data 206 action, the GNSS position and time data is read, as well as the data from the 3-axis accelerometer and from the 3-axis gyroscope. This process step also serves as a return point for continued readings as previously described at a high level in the PNT loop 195 discussion of multiple attempts to read GNSS process step 194 but will be described in detail along with the validate data process step 196.

Once data from the GNSS/IMU1 module has been collected, the data is examined to determine that the data appears legitimate, appropriate, and complete in the data legitimate decision 207. Corrupted data, partial data, zero data, max value data, and nonsense data are generally not to be considered legitimate. If not, then the system will set flag for failed read 209 for each of the types of data that failed to read and will then proceed to store event log 214. Once the event is stored with the best available time stamp, a security alert 215 will be issued, meaning a flag will be set designating that a security event has occurred and designating the event as a failed read. Once one or more appropriate security flag(s) are set, the system task flow completes this pass through the PNT loop 195 and the system is returned to the orientation loop 188 through the PNT update end 218. This PNT update end 218 is the local block diagram representation of the PNT-orientation transition 197 arrow in the system loop diagram of FIG. 4.

In at least one configuration, a set of data where only the GNSS fails to read would set a flag but preferably would not send the system to proceed to store event security log 214 but would instead proceed to review remaining data with the boundary decision 208. In such configurations, the system can continue operating on IMU1 data even if the GNSS data is unavailable. In at least one configuration, this decision to abort or continue with incomplete data is at least partially based on a system configuration setting. In at least one configuration this decision to abort or continue with incomplete data is at least partially based on recent system flags regarding mission operating conditions.

Testing the example down a different path, back to the data legitimate decision 207, if the data is determined to appear legitimate, appropriate, and complete, then the system will proceed to the in bounds decision 208. This decision step examines the data of the most recent collection event and compares the data to a set of values representing boundaries. For the GNSS location, the set of values represent allowable latitude, longitude, and elevation values permitted for the buoy, with the assumption that any value outside this expected set of boundaries is highly likely to be, and/or is a spoofed location and therefore invalid. For the IMU1 linear acceleration and angular acceleration data, the expected set of boundaries reflect an assumed minimum and maximum value that reflect values that would be experienced in operation. Any data outside these values is not likely to be real, and therefore all data in the set is suspect and should not be used for calculating orientation and position. If data is outside expected boundaries, the system will proceed to set boundary fail flag 213 and store the event and notify security as before. In at least one configuration, a set of data where only the GNSS fails outside of the boundary would set a flag but would not proceed to event security log 214 and instead allow the system to continue with impartial data.

Continuing the example with data, the system proceeds to store data 210. In at least one configuration, this stored data includes storing the GNSS data if complete and if in bounds. In at least one configuration, this stored data includes storing the IMU1 accelerometer data if complete and if in bounds. In at least one configuration, this stored data includes storing the IMU1 gyroscope data if complete and if in bounds. The system then proceeds to compare data to log 211, which means comparing the time stamp of the data to what is presently stored in the recent log file.

In at least one configuration, the system answers the data new decision 212 based on at least one of the time stamp and the data content to determine if anything has changed. If the data has changed, then the system proceeds to set new data flag 216 and proceeds to the request flag decision 217. If the data has not changed, then the system proceeds directly to the request flag decision 217.

At the request flag decision 217, the start location flags are reviewed. If the PNT flag was set originally at PNT update 203 then the system ends the time in the module by moving to return to the orientation loop 188 through PNT update end 218. If the PNT flag was not set, then the system checks to see if the comms flag was set at comms update 202. If so, then the system moves to the PNT log data process step 219 to determine if there is recent data already present. If so, then the module moves to return to the comms loop 190 through comms loop end 220. This end point represents the block diagram representation of the PNT-comms transition 193 arrow in the system loop diagram of FIG. 4.

If there is no recent data to reference for the PNT data log decision 219 then the system moves to wait and track 221 to attempt to retry to gather new data. The system waits 500 msec (half a second), increments a trial counter (not illustrated) by one, and proceeds to the third time decision 222. If the trial counter is below three, then the answer is no and the system resets back to read GNSS data 206 again to try and retake the data.

If the trial counter is at least three, then the trial counter is reset, and the system moves to alert recipient 223. Here the system sets a system flag noting the failure to obtain data in time and proceeds to end the time in this system module with a timeout comms end 224. In at least one configuration the timer resets after ten (10) tries. In at least one configuration the timer resets after a number of tries defined by at least one of the system configuration file and system flags regarding mission operating conditions.

It is well known to those of ordinary skill in the art of microprocessor coding that a wide range of system languages can be used to create the functions described in the process flow chart of FIG. 2, the system control loops of FIG. 4, and methods block diagram of one loop in FIG. 5. The methods for calculating orientation, for example, would follow a very similar pattern as the one used for the PNT loop, but would include the actions of calculating the gravity and Magnetic North vectors from the magnetometer, IMU1, and IMU2 data.

Returning to the subject of system process steps performed in accordance with at least one example illustrated in FIG. 2 is the matter of the calculations performed by Processor 2 while Processor 1 is busy maneuvering through the system loops of FIG. 4 during operation. In particular, attention is brought to the processes apply an EKF to IMU1 81 and apply an EKF to IMU2 82. As previously described, these processes are for Processor 2 to apply an EKF to the data that was retrieved and validated by Processor 1 during the operations described in detail above. The justification for the importance of these processes is illustrated in the data graphs of FIGS. 6a through 6c, which show unfiltered data, filtered data, and subsequent swell position calculations made on both unfiltered and filtered data.

Referring to FIG. 6a, a graph of swell IMU1 acceleration 225 with a horizontal axis showing acceleration data points 226 by numerical count and a vertical axis showing acceleration data value 227 by meters per second per second (m/s\hat{ }2). The acceleration data points 226 shows the data points occurring from the 6,000th data point to the 10,000th data point as seen in the axis scale. In at least one configuration, the data points were collected at the rate of thirty per second (30 Hz). The acceleration data value 227 axis is seen to range from −2.0 m/s\hat{ }2 to +2.0 m/s\hat{ }2 in accordance with the scale.

The need for signal processing is seen in the IMU1 acceleration raw data 228, which shows a sequence of data points in succession, with a total of 4,001 data points illustrated in the aggregate IMU1 acceleration raw data 228 of FIG. 6a. The data points are seen to vary wildly across range of approximately −1.2 m/s\hat{ }2 up to +1.9 m/s\hat{ }2 with high variance from one data point to the next despite the actual motion of the swells being comparatively smooth.

There is a high level of noise on this data as well as an overall positive drift. The centerline (not shown) average is well above the zero level, which would result in calculations of velocity and position drifting upwards into the sky. The actual data is about the zero axis because each time the buoy rises to a swell apex, there is a corresponding dip into a trough nadir, and the buoy typically does not go airborne once deployed in the water due to the overall density of the buoy being substantially greater than that of air. Similarly, the buoy typically does not sink once deployed as the overall density of the buoy is substantially lower than that of water.

Noisy data can be cleaned up using signal processing, and generally only some types of signal processing can be performed on each incoming data point immediately prior to use. One of these types is a Kalman Filter, which assumes Gaussian noise distribution of incoming sensor data. A type of Kalman Filter used for non-linear sensor responses is an EKF which approximates the non-linearity using a first or second-order derivative.

In at least one configuration, an EKF using a first-order derivative is used on acceleration data representing the vertical motion of wind and weather-perturbed open water. It is contemplated that in at least one configuration, a Kalman Filter is used to compensate for the sensor noise in a relevant axial dimension and measurement type. It is further contemplated that in at least one configuration an EKF using a second-order derivative is used to compensate for sensor noise in a relevant axial dimension and measurement type.

In at least one configuration, an EKF is used with a covariance value K=4 to dampen the effects of noise resulting in the IMU1 filtered data 229. The data points are now so close together they appear as a continuous unbroken line although they have been plotted as discrete points exactly as the IMU1 acceleration raw data 228. In at least one configuration the data points have been filtered immediately as they are collected in accordance with one common implementation technique for EKF signal processing. Kalman Filters of all types can be used in sensor applications because they do not have to include any specific expectations and can be applied to highly noisy data as the data enters the processor so you get “real time results” of each new value to use for calculations.

In the IMU1 filtered data 229, the cyclic period of the swell motion is seen to occur with a period of approximately 8.5 seconds, which is representative of the type of data that would be collected in an open-water marine environment of mild to moderate weather. In at least one configuration, some high frequency acceleration content is seen as a rapid perturbation occurring faster than the major peaks. It is not clear from the IMU1 filtered data 229 alone if this high-frequency perturbation is real and experienced by the sensor module or if the perturbation is a by-product or residual of the EKF signal processing step. In at least one configuration of studying oceanic swell behavior and buoy position thereupon, the difference is irrelevant as buoy height is based on integrated acceleration, now referred to as velocity to make further calculations and relevant observations for decision-making.

The effect of the noise in the original acceleration data is illustrated in FIG. 6b, which presents the global z-axis velocity of the buoy over time as swell IMU1 velocity 230. This graph has a horizontal axis showing velocity raw data 231 by numerical count and a vertical axis showing velocity raw value 232 by meters per second (m/s). The velocity raw data 231 shows the data points occurring from the 4,000^{th} determined data point to the 6,000^{th} determined data point as seen in the axis scale as integrated from raw acceleration data collected at the rate of thirty per second (30 Hz). The velocity raw value 232 axis is seen to range from approximately −1.5 m/s to +2.7 m/s in accordance with the extrapolated scale.

After each one-second interval consisting of thirty points of data, the integration total is zeroed out and the integration effort begins anew for each segment of one second. In at least one configuration, integration intervals are selected to be one second of time as the intended purpose of this signal processing step is to assess the vertical height position of a buoy relative to ocean wave and swell motion. Typical ocean waves and swells occur with major periods between six and fifteen seconds (6-15 sec) and therefore one second is a reasonable segment of time for study. It is contemplated that in other applications of sensing motion of terrain roughness or airborne turbulence, alternative periods of integration may be selected to better characterize those environments.

The impact of noise on the velocity calculation is evident in the velocity raw plot 233, which shows a sequence of staccato ramps that have a wide variety of short and tall ramps. The impact of drift on the velocity calculation is evident in that the majority of the resulting ramps present in the velocity raw plot 233 are upward and with a variable number of ramps upwards before experiencing a ramp downward. This means that most of the acceleration data is positive and therefore most of the integrated values remain positive. There is little evident correlation of a smooth, periodic motion in the velocity raw plot 233 therefore the position of a buoy relative to a swell apex or trough nadir is not readily discernible. It is contemplated that at least one signal processing analysis technique may be able to determine where the swell peaks and troughs are located in the velocity raw plot 233, but that the repetitive nature of swell motion is not apparent in this data.

With respect to FIG. 6c, the filtered IMU1 velocity 235 graph shows the same data as the swell IMU1 velocity 230 graph except the acceleration data has been passed through the same EKF described in the detailed description of the swell IMU1 acceleration 225 graph, a first-derivative EKF with a covariance value K=4. This graph has a horizontal axis showing velocity filtered data 236 by numerical count and a vertical axis showing velocity filtered value 237 by meters per second (m/s). The velocity filtered data 236 shows the same data points occurring from the 4,000^{th} determined data point to the 6,000^{th} determined data point at 30 Hz. The velocity filtered value 232 axis is seen to have a tighter range from −0.4 m/s to +0.5 m/s in accordance with the scale.

When the same acceleration data has been filtered through an EKF prior to integrating into velocity, a very different graph emerges. The velocity filtered plot 238 shows a readily evident periodicity matching the 8.5 second period of the acceleration data, and the velocity is seen to have a series of positive values then a series of negative values, exactly in line with the motion up and down the swell profile. No regression flattening is performed due to the short integration times, so a net trend of larger positives than negatives is seen, so the impact of drift has been mitigated but not eliminated.

When the velocity transitions from positive velocity to negative velocity, it means the buoy has reached the swell apex and is about to start traveling down again. Conversely, when the velocity transitions from negative velocity to positive velocity, it means the buoy has reached the trough nadir and is about to start traveling up again.

The top of the swell major peak for transmission defined as transition from three positive velocities to one negative velocity, meaning the buoy has started traveling down for one second already as the buoy crested the top of the wave. A swell major trough defined as transition from three negative velocities to one positive velocity, meaning the buoy is starting on the way back up. In at least one configuration, the time to begin transmitting during swell motion equivalent to sea state 3 is the time after two positive velocity seconds. In at least one configuration, the time to begin transmitting during swell motion equivalent to sea state 4 is after three positive velocity seconds, as the buoy needs time to reach closer to the apex of the wave before transmission is likely to be received.

In at least one configuration, implementing a swell detection method based on an EKF using a first-derivative and covariance of K=4 results in the majority of apexes of major peaks and the majority of the nadirs of major troughs occurring during sea state 3 conditions being correctly identified. It is contemplated that in at least one configuration, different covariance factors are used for different axes of IMU1 and for different axes of IMU2. In at least one configuration, the covariance factors of at least one EKF are dynamically adjusted based on at least one of the configuration settings and recent system flags regarding mission operating conditions. In at least one configuration, the equivalent sea state is determined using integrated velocity data to estimate the swell apex height and the trough nadir depth.

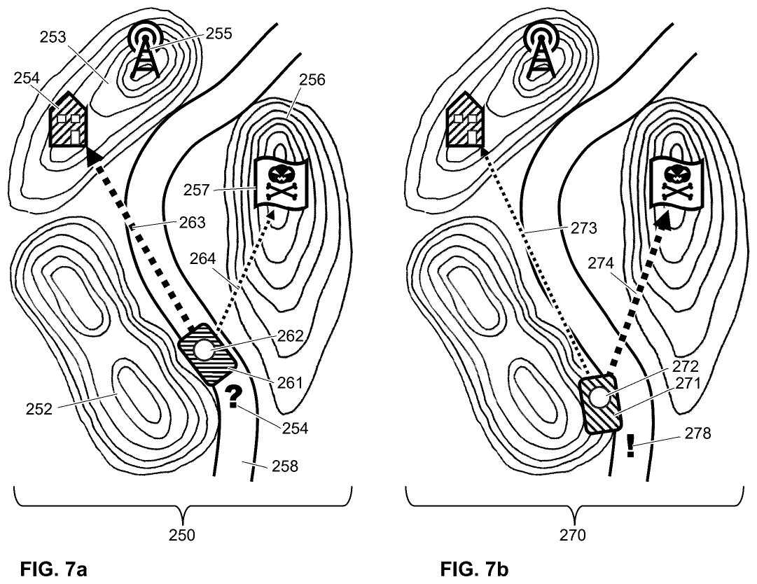

A different application example is provided in the plan view illustration of an unattended ground vehicle (UGV) performing maneuvers and targeting operations in contested territory but taking advantage of the presently disclosed subject matter to improve tactical awareness and improve targeting accuracy. The same scene is presented twice in FIGS. 7a and 7b; FIG. 7a an initial estimated scene 250 where the initial UGV estimate 261 is inaccurate and FIG. 7b is a revised estimated scene 270 where the revised UGV estimate 271 is significantly more accurate in the representation of actual global conditions, positions, and object orientations including the estimate of the UGV of itself.

In the initial estimated scene 250, a UGV is shown entering a contested environment illustrated as a topographical plan view map with features of relevant interest. All items shown are in their real and actual locations except for the UGV itself, which believes that the UGV is located in and oriented as seen for the initial UGV estimate 261. The contested environment is shown containing a road 258, a near hill 252, a far hill 253, and a hostile hill 256.

Atop the far hill 253 is a static feature 254 illustrated as a prominent farmhouse for clarity of reference. An important detail about the static feature 254 is that the position and orientation are known to those operating in the contested area and are located and referenceable in the map data used by the UGV. Also atop the far hill 253 is a jammer 255, which is performing duties admirably as the jammer eliminates the ability of the UGV to locate itself accurately using GNSS resources. The direction of the GNSS jammer 255 is determinable through the readily detectable radio frequency emissions, although the jammer is not precisely located on any map data as the object was placed recently.

Atop the hostile hill 256 is a hostile agent 257 represented by a pirate flag. The hostile agent 257 is considered a high-value target to the UGV as the hostile agent is the base of operations for criminal enterprise that is destabilizing the region and contesting the lawful control of the UVG (i.e., the commander of the UVG). The UGV would like to target the hostile agent 257 using targeting sensor 262 but the UGV is generally incapable of the foregoing because the UGV has not determined the location of itself. The targeting sensor 262 contains both an electro-optical/infrared (EO/IR) camera and a targeting laser that the UGV wishes to use to target hostiles 264 (vector shown as thin dashed arrow).

Unfortunately, without accurate starting coordinates, the targeting laser will not provide the proper target location to long-range allied kinetic energy delivery resources (e.g., artillery, not shown). Because of the fortified position of the hostile agent 257, kinetic energy deliveries even a few tens of meters off-target will be ineffective.

The UGV operator therefore suffers from PNT confusion 254 and needs to correct the location and orientation of the UGV. The approach to correction is to employ multiple sensor assets to correct location and orientation. Fortunately, the targeting sensor 262 incorporates one configuration of the presently disclosed subject matter. The sensor determines that the present terrain being traversed has a high roughness, so the operator knows that the vehicle is not actually located on the road 258.

The surface roughness is measured to be greater than the roughness that enables the targeting sensor 262 to operate at full capability. In at least one configuration, the targeting sensor 262 is able to be used while on the move over flat terrain, but the vibration of rough terrain means that the UGV will likely be unable to use the laser for range-finding or the EO/IR camera at high magnification settings. Additionally, in at least one configuration, object recognition system is known to not operate under high vibration conditions, so to identify objects while not on flat terrain, the A.I. control system of the vehicle determines that the UGV is likely going to be required to slow or stop.

The sensor also determines that the vehicle is angled at a slope facing East-Northeast. Checking the topography of the map data, the A.I. control system suspects that the vehicle might actually be located on the side of the hill, not the road. The orientation sensor further provides notice that the UGV is not facing Northwest but is instead facing North-Northwest. These three clues from the IMU sensor data serve to assist in the correction of the physical location and orientation of the UGV in the environment.

Based on the physical sensor input, the UGV stops traveling so the UGV can use the targeting sensor 262 at full capability. The UGV turns targeting sensor 262 to target the known static feature 254 using the approximate direction to target feature 263 with the final aim direction corrected by image recognition system. The orientation of the targeting sensor 262 is also measured during this operation. The act of measuring range and actual direction to target feature 263 defines a vector that can now be used to assist in recalculating exact location and orientation of the UGV.

In at least one configuration, an optical imaging sensor is used instead of an optical rangefinder to provide a direction to a known static feature 254. In at least one configuration, the optical imaging sensor is a lidar sensor.

In at least one configuration, a radio frequency sensor is used instead of an optical targeting sensor, providing a direction to a known radio emitter. In at least one configuration, the known radio emitter is a stationary radio tower. In at least one configuration, the known radio emitter is a consumer Wi-Fi router located in a civilian structure. In at least one configuration the known radio emitter was precisely located using at least one radio frequency direction finding asset sufficiently far in at least one of time or distance from the present effect of the jammer 255.

Using the actual feature vector 273 and the three physical sensor inputs, a PNT correction 278 is realized which defines the corrected UGV estimate 271 in a revised estimated scene 270. The targeting sensor 262 is now turned to engage hostile agent 257 as an engaging sensor 272 which readily measures an actual hostile vector 274. The actual hostile vector 274 is now able to be transmitted to the decision-makers responsible for at least one long-range allied kinetic energy delivery resource for further consideration.

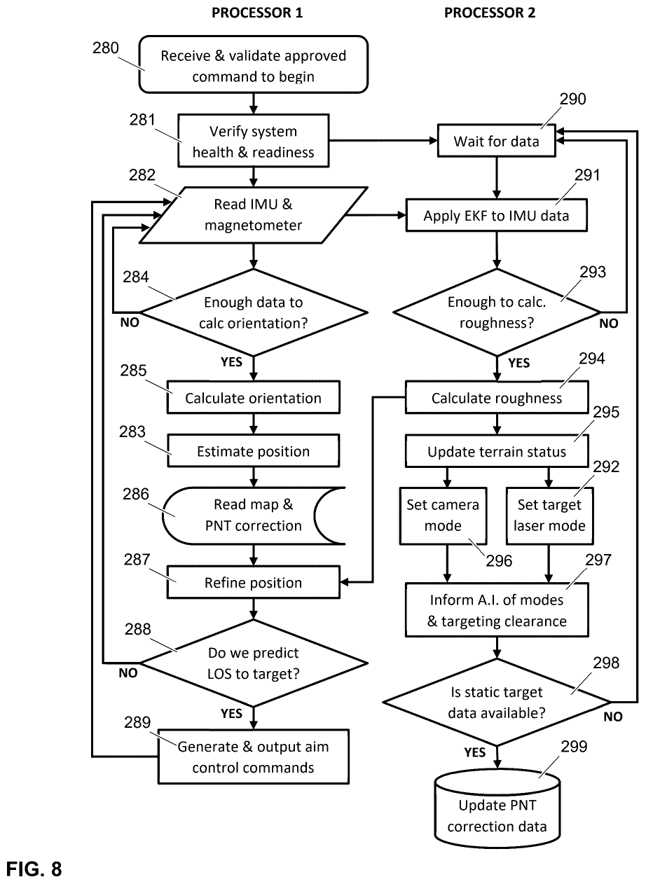

The example at least one configuration of FIG. 7a continues with a flow chart of processor activities for schematically illustrated in FIG. 8. This flow chart is followed by the incorrectly oriented targeting sensor 262 and correctly oriented engaging sensor 272 illustrated in FIG. 7a. The illustration separates the activities of at least two processors working together, hereinafter referred to as Processor 1 and Processor 2, into two columns. The flow chart begins with receive command start 280 whereupon prior to start at least Processor 1 has been powered on and is ready for receiving commands from commanding agent. In at least one configuration, the commanding agent is the UGV A.I. control system. Processor 1 has the structure configured to approve at least one of the authenticity of the command and the commanding agent. During receive command start 280, Processor 1 receives a command from an external commanding agent and authenticates the validity of the command and proceeds to the first process.

The first process is to verify system readiness 281, during which Processor 1 checks system state flags for readiness, ensures system power is ready, and all required hardware elements are powered up and operating. Once the system is verified as ready for action, Processor 1 informs Processor 2 that Processor 1 may now prepare itself to wait for new data 290. Once Processor 2 is started up, Processor 1 moves ahead with the data input gathering actions.

Processor 1 gathers data during the read sensors process step 282, whereupon Processor 1 polls the IMU and magnetometer sensors. Once the data is collected, the data is made available to Processor 2 and Processor 1 is free to move on. Note that read sensors process step 282 is a return point for the process flow in at least one configuration of the presently disclosed subject matter so the process is effectively “free running” with updating of position and orientation until communications fail due to power availability or the system calls an end to the activity.

Processor 1 examines the data from the IMU and magnetometer at the enough orientation data 284 decision action. If the data quantity or quality (or both) are insufficient to determine the orientation of the sensor, then the process flow proceeds back to the read sensor data 282 action. If the data quantity and quality are sufficient to determine the orientation of the sensor, then Processor 1 proceeds ahead to calc orientation 285. In this process, the data from the IMU and the magnetometer is used to determine two vectors relative to sensor orientation.

The first vector determined is the direction of Magnetic North of the Earth, which is readily determined from 3-axis magnetometer data in the three cardinal directions based on the frame of reference of the magnetometer module. In at least one configuration, the combination of one gravity vector and one Magnetic North vector is sufficient to estimate the orientation of the sensor platform with an accuracy that is calculable based on the noise level and accuracy of the sensor. In at least one configuration, the calculated estimated North vector will be within 2 degrees of the true Magnetic North vector.

The second vector determined is the direction of gravity, which is readily determined from IMU acceleration data in the three cardinal directions based on the frame of reference of the sensor. In at least one configuration, the determined estimated gravity vector will be within two (2) degrees of the true gravity vector.

Now that Processor 1 has estimated gravity and North vectors, Processor 1 determines the orientation of the sensor modules and, therefore, the targeting sensor 262 relative to these vectors.

Proceeding to the estimate position 283 step, Processor 1 estimates the position of the UGV based on available sensor data and any available GPS, other, or other PNT service location data provided locally, historically, or remotely. This forms the baseline local estimation of position forming an initial UGV estimate 261 from FIG. 7a. The only variance from the initial UGV estimate 261 available in this step is to correlate the additional sensor input of orientation which is now known to Processor 1.

The next step is to retrieve map data including available topographic data and any PNT correction information previously stored in the read map 286 retrieval process step. This is a straightforward use of computing resources and memory access. Once retrieved, Processor 1 is able to use the map topographical data and the perceived terrain roughness to refine the estimate of the location of the UGV in the refine position 287 process. The orientation of the sensor is also used to cross reference with topographical data at this time to determine if the vehicle is on a slope and, if so, if that slope matches up with the Magnetic North vector and gravity vectors presently being experienced. If the terrain roughness is at a specific level, does that match up with expectations based on available map data, e.g., is the vehicle presently off road, in sand or gravel, or in some other terrain measurable and differentiable by the physical sensors?

Once the estimate of the position has been refined based on available map topographical data, PNT correction, and physical sensor data, Processor 1 proceeds to determine whether there is a target of interest and if the target is within line of sight (LOS) in the predict LOS 288 decision. If the prediction is no, then a flag will be set that an intended target is not likely in LOS and Processor 1 returns to gather new data back at read sensors process step 282. If the prediction is yes, then a flag will be set that an intended target is likely within LOS, and Processor 1 is permitted to proceed to generate control commands.

With the available information, Processor 1 is ready to perform the aim control commands 289 action. In at least one configuration, Processor 1 determines the difference between the preferred aim direction and the present orientation and uses this difference to define a local array aim direction. In at least one configuration, Processor 1 converts a local array aim direction into a set of control commands configured to drive a phased array. In at least one configuration, a set of control commands configured to drive a phased array require a command conversion device to translate a command into digitally selected phase state settings. In at least one configuration, Processor 1 converts a local array aim direction into a set of control commands configured to drive at least one mechanical actuator. In at least one configuration, the mechanical actuator to be driven includes at least one of an azimuthal (pan) and an elevation (tilt) actuator. In at least one configuration, Processor 1 converts a local aim direction into a set of phase data used for digital correction of baseband data. In at least one configuration, a set of phase data used for digital correction of baseband data is used for received data alignment prior to summation. In at least one configuration, a set of phase data used for digital correction of baseband data is used for up-conversion and transmission for constructive interference in a phased array.

Once aim control calculations have been prepared in the first step of the aim control commands 289 process step, Processor 1 will then output aim control commands by way of at least one communications method. In at least one configuration, one communications method is by wired communication protocol to a pan-tilt-zoom control board. In at least one configuration, one communications method is by a wireless radio transmission having a waveform and data in compliance with at least one wireless communications standard protocol. In at least one configuration, one communications method is by wired communication protocol to a processor performing digital signal processing of baseband data.

Once the aim control commands have been transmitted, in at least one configuration Processor 1 reverts back to read sensor data 282. In at least one configuration, Processor 1 will check a system status flag first to determine if additional control is still needed and, if not, will exit the process flow diagram.

The process flow diagram example of FIG. 8 proceeds to describe the actions undertaken and questions addressed by Processor 2 in parallel with the previously aforementioned activities of Processor 1. At the start of Processor 2 activities is the process to wait for new data 290. In this process, Processor 2 is waiting for a specific flag to be set by Processor 1 which is used to acknowledge the completion of the read sensor data 282 step.

When the read sensor data 72 flag is noted as being set, Processor 2 proceeds to apply the mathematical process of an EKF to the IMU accelerometer and gyroscope data in the apply an EKF to IMU 291 process. In this process, the IMU data is modified by Processor 2 in accordance with an EKF set to remove noise from the data from each of the three cardinal axes relative to the orientation of the sensor.

Once IMU data has been filtered, Processor 2 asks if there is enough data present to determine terrain roughness 293 as a significant decision. In at least one configuration the answer is generally related to the total amount of data collected to date since the start of the deployment of the UGV and the answer will be “yes” once data has been collected for at least five seconds. In at least one other configuration, the answer is yes once data has been collected for at least one second to first characterize terrain roughness with sufficient speed that resultant calculations can be used to aid in navigation and traction control.

Once sufficient data has been collected to make a determination of terrain roughness, Processor 2 progresses to the determine roughness 294 process. In this process, the filtered IMU data is integrated over time to create a velocity vector. In at least one configuration, the velocity vector is determined for velocity in the global vertical (z) direction relative to (aligned with) the true gravity vector. In at least one configuration, the velocity vector is determined for velocity in the relative vertical (z) direction normal to the nominal surface based on locally experienced average slope. The method of calculating vertical velocity will be understood by one of ordinary skill in the art of geometry. In at least one configuration, the result of the determine roughness 294 process includes the estimation of the axial orientation of the UGV. In at least one configuration of the presently disclosed subject matter, the filter characteristics used to reduce noise in the IMU data will be updated during operation. The terrain roughness characteristics are stored in data accessible to Processor 1.

The status of terrain roughness is next updated in the update terrain 295 action. Processor 2 compares the surface roughness to previous data on surface roughness and determines if the local conditions experienced by the UGV have changed. In at least one configuration, the local terrain is updated slowly over time using stored historical data. In at least one configuration this update occurs every second to match the approximate time frame of the rate of driving from a road on to a shoulder. It is envisioned that a wide variety of update rates can be used within the expected set of configurations in accordance with the presently disclosed subject matter, and a set of update rates might range from between every second to every minute depending on the type of data desired in a specific implementation and deployment. In at least one other configuration, the terrain roughness or other external environmental characteristics are neither measured nor determined.

Once the terrain roughness has been established as a local environmental condition for UGV operation, Processor 2 determines what modes of operation for available assets shall be permitted. These calculations are made for two sensors in FIG. 8 in the set camera mode 296 and set laser mode 292 actions. This calculation for allowed mode may also consider at least one of the nominal terrain roughness, the global terrain type, local weather conditions, visibility, and situational awareness level from other sensor input to determine which mode should be selected. In at least one configuration, the locally experienced surface roughness and speed are used to determine if a targeting laser can be used for ranging and vector determination to a nearby target. In at least one configuration, the locally experienced surface roughness, terrain type, and speed are used to determine if object recognition methods can be used on EO/IR sensor data for a target with mild visible obstruction. In at least one configuration, these calculations are made in serial fashion. In at least one configuration, these calculations are made simultaneously with a single lookup table reference.

Once the modes of the attached equipment have been recommended, the vehicle A.I. needs to be updated with this information in the inform A.I. process step 297. In at least one configuration, the recommended camera mode and laser rangefinder modes are provided by a structure configured for communication to the vehicle A.I. In at least one configuration at least one of the recommended camera mode and laser rangefinder mode are set with a system flag. In at least one configuration at least one of the recommended camera mode and laser rangefinder mode are provided by a structure configured for communication to an external agent.

Processor 2 proceeds to ask a question regarding whether or not data is available regarding at least one of the direction to and range to a known static reference target. This question is asked in the static target data decision 298, and the answer depends on whether or not at least one component of a vector to a known reference exist to help correlate location and orientation the next time Processor 1 refines the estimate of position. If no such data exists, Processor 2 returns to wait for new data 290. If such data exists, Processor 2 prepares the data for PNT correction purposes and stores the data in the update PNT data 299 data storage process step. This data will be retrieved by Processor 1 the next time Processor 1 enters the read map 286 retrieval process step, and this correction will be used to refine the future UGV estimation.

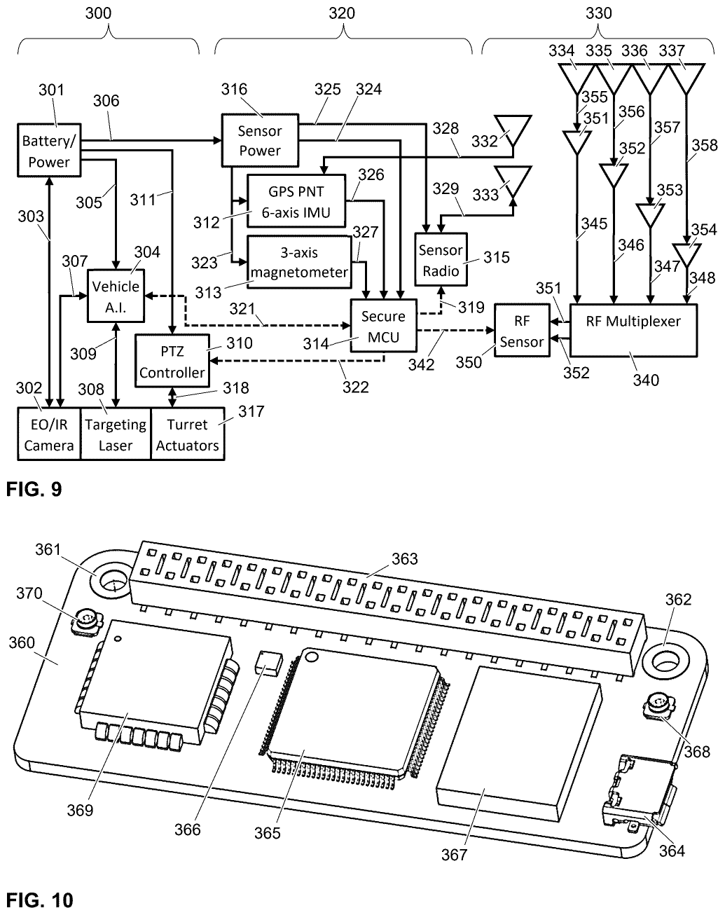

At least one configuration of hardware suitable for supporting the process flow chart of FIG. 8 is provided in the hardware block diagram of FIG. 9. A vehicle turret region 300 is connected to a sensor region 320 which is connected to an RF sensor array 330. A plurality of connectivity is described herein to describe how these circuit and component elements interact to provide the capability illustrated in FIG. 8 and described previously associated therewith.

In at least one configuration, a vehicle battery 301 provides power to a plurality of systems described herein. The vehicle battery 301 provides sensor power 306 to the sensor power block 316, provides computing power 305 to the vehicle A.I. 304, provides optics power 303 to the EO/IR camera 302 and targeting laser 308, and provides turret power 311 to the PTZ controller 310. The vehicle battery 301 also provides power to the RF sensor array 330 elements but these connections are not illustrated for the sake of brevity and clarity of the diagram.

In at least one configuration, the EO/IR camera 302 provides video data 307 to the vehicle A.I. 304. At least one intended role of the vehicle A.I. 304 is to operate the camera and targeting laser 308 to gather targeting data 309 that can be utilized for at least one of internal purposes and for sharing with at least one external agent not shown using a structure configured for communication not shown in FIG. 9. The vehicle A.I. 304 is also capable of sending and receiving at least one of data and commands by way of a secure signal 321 which is itself electrically connected to a secure processor 314.

In at least one configuration, the vehicle A.I. can engage the PTZ controller 310 directly, but in at least one configuration the PTZ commands 322 only arrive by way of the secure processor 314 to ensure orientation and location correction is applied. The PTZ controller 310 generates, modulates, and transmits PTZ power 318 to drive the turret actuators 317 to aim the turret in azimuth and elevation as well as stabilize the turret when the vehicle is in motion.

Turning to the sensor region 320, the sensor power block 316 provides module power 323 to the PNT module 312 and to the magnetometer 313. The sensor power block also provides processor power 324 to the secure processor 314 which in at least one configuration is comprised of multiple direct current voltage levels and power lines ranging from between +1.8V and +3.3V in voltage level as referenced to local ground. The sensor power block 316 also provides sensor radio power 325 to the sensor radio 315. Voltage and current levels for power electronics, including power conversion, electromagnetic emission generation, electromagnetic sensitivity, noise control, safety circuitry, wire selection, and PCBA trace and power plane design are all well known to one of ordinary skill in the art of electronics.

The PNT module 312 is the sensor module that provides inertial measurement data used to determine orientation relative to gravity measure terrain roughness. The PNT data 326 is accessible to secure processor 314. This module also contains an RF receiver circuit that translates the GPS signal 328 into PNT data. In at least one configuration, the GPS signal 328 is a combination of received signals from multiple satellites of at least one constellation of satellites as received by the GPS antenna 332. The PNT module modifies these received signals and provides an approximate global location for the vehicle. Unfortunately, GPS transmissions are easy to jam or spoof with false locations, and therefore should not be relied upon in contested environments such as in the example of FIGS. 7a and 7B.

The magnetometer 312 provides three axes of magnetic data used to determine orientation relative to Magnetic North. Magnetometer data 327 is accessible to secure processor 314.

The secure processor 314 is the primary engine for the calculations and decision-making activities of at least one configuration of the presently disclosed subject matter. In at least one configuration the secure processor 314 itself contains both Processor 1 and Processor 2 with duties as described in FIG. 8, and the two processors share a commonly accessible memory bank to readily share data and set and read flags between them.

A sensor radio datalink 319 provides a structure configured for communication between the secure processor 314 and authorized external agents by transmitting and receiving signals through the sensor radio 315. The sensor radio signal 329 is an RF signal connected through to the sensor antenna 333, an antenna having an azimuthal toroidal antenna pattern. Separately, by structure configured for the control datalink 322, the vehicle A.I. 304 is also able to operate the sensor radio 315 through the sensor radio datalink 319. Commands and data can be sent and received through the sensor radio as a wireless structure configured for communication.

A sensor orientation signal 342 is generated by the secure processor 314 and sent to the RF sensor 350 to correct the baseband signals received by the array. In at least one configuration, the sensor orientation signal 342 is carried across a wired path between the sensor region 320 and the RF sensor array 330 as a structure configured for communications.

In at least one configuration, the RF sensor array 330 is comprised of antennas that receive and amplify RF signals. A first element 334 captures a first received signal 355 and passes the signal to a first LNA 351 to create a first LNA signal 345. Similarly, a second element 335 captures a second received signal 356 and passes the signal to a second LNA 352 to create a second LNA signal 346. Also similarly, a third element 336 captures a third received signal 357 and passes the signal to a third LNA 353 to create a third LNA signal 347. Lastly, a fourth element 337 captures a fourth received signal 358 and passes signal to a fourth LNA 354 to create a fourth LNA signal 348.

Each of the four LNA signals are passed into an RF multiplexer 340. The RF multiplexer 340 selects any two incoming received and amplified signals and presents them as a first selected signal 351 and a second selected signal 352 to the RF sensor 350. Inside the RF sensor 350, different combinations of the received signals are adjusted in at least one of phase and amplitude to correlate the received signals into a combined signal that has arrived from a determined direction. In at least one configuration, the determined direction of origin of at least one received signal was previously unknown prior to calculation. In at least one configuration, phase differences between at least two received signals are used to determine the direction of origin of at least one received signal. In at least one configuration orientation correction factors provided by the secure processor 314 are used in the calculation of the direction of origin for correlating at least two received signals.

At least one configuration of exemplary hardware in the block diagram of a sensor region 320 are shown in the form of a printed circuit board assembly (PCBA) with populated components in FIG. 10. The controller PCBA 360 is a rectangular board with multiple major components illustrated and described herein with direct correlation to their block diagram entries in FIG. 9. The sensor power block 316 of FIG. 9 has been populated on the back of the controller PCBA 360 and is not visible. The details of the wires, traces, and support components have been suppressed in the interest of diagram clarity, and their selection, placement, and wiring is generally known to one of skill in the art of conventional electronics hardware design and layout.

In at least one configuration, the controller PCBA 360 can be 60-mil thick Isola FR408 material, a thickness that provides suitable mechanical support for component assembly and deployed subsystem operating conditions. Isola FR408 has a design-in dielectric constant of approximately 4.4 at the frequencies described herein and can be readily manufactured in high-volume printed circuit card processes and materials. In at least one other configuration, the controller PCBA 360 can be 60-mil thick Shengyi S1190M material also having a dielectric constant of approximately 4.4 at the frequencies described herein and also having high-volume manufacturing availability.

A wide variety of printed circuit board and polymer materials may be used for the controller PCBA 360 without departing from the scope of the features disclosed herein. For example, such features can include, but are not limited to, numerous FR-4 variants and other epoxy-filled glass fiber printed circuit board materials from many vendors, polypropylene, polyester, nylon and the numerous such variants, esoteric materials such as Rogers RO4350B, and other polymer, epoxy, glass fiber, and dielectric materials used in the microwave components and circuits industry.

In at least one configuration, the controller PCBA 360 uses two conductor layers, such as a first side and a second side of a printed circuit board with vias that electrically and mechanically connect between the conductor features located on each of the two sides. This configuration for the controller PCBA 360 provides for a relatively low-cost antenna design that can readily be scaled to high-volume manufacturing. In at least one configuration, the electrically conductive layers can be formed from at least one of copper, silver, aluminum, nickel, gold, their alloys, and their solders, or any other electrically conductive material.

In at least one configuration, the material of the controller PCBA 360 may include layers that are comprised of materials that are conductors, including but not limited to aluminum stock or alloys made by other forming methods, copper and alloys thereof, any of various types of steels, heavily doped semiconductors such as silicon or gallium arsenide, conductive polymers, conductive nanofiber composites, superconducting materials, and other liquid, solid, and composite homogenous and heterogenous conductors used in radio frequency component and PCBA manufacturing.

It is further contemplated that in other configurations, materials of the controller PCBA 360 may be fashioned by other techniques including but not limited to machining, molding, casting, electrical discharge machining, 3-D printing, selective doping, self-assembly through surface tension, and other additive, subtractive, electron mobility manipulation/percolation, and motive energy management techniques for forming conductors.

In at least one configuration, the physical planar size of the controller PCBA 360 is 28 mm by 64 mm. In at least one configuration, the controller PCBA is 16 mm by 20 mm using small components and connectors to perform the disclosed functions. In at least one configuration, the controller PCBA is 250 mm by 400 mm and connects multiple parallel sensors and actuators responsible for accomplishing similar activities with relatively greater precision and control capability, but at higher cost. It is contemplated that other physical sizes of the controller PCBA 360 containing one or more of the block diagram elements of the sensor region 320 are possible without diverging from the presently disclosed subject matter.

In at least one configuration, the controller PCBA 360 includes one or more mounting holes for attachment to other objects. The controller PCBA 360 of FIG. 10 is configured with a first mounting hole 361 and a second mounting hole 362 appropriate for the passing through of fasteners. In at least one example, the first mounting hole 361 and second mounting hole 362 are configured to accommodate threaded fasteners such as machine screws. In at least one example, the accommodated screws have a 4-40 diameter. In at least one example, the accommodated screws have an M3 diameter.

Although two (2) total unthreaded mounting holes are illustrated in FIG. 10, the number of mounting holes through the controller PCBA 360 can be more or less and can be threaded or unthreaded dependent upon a particular mounting configuration. Moreover, in at least one other configuration other mounting configuration can be used with the controller PCBA 360, including the use of one or more mounting brackets (not shown) without diverging from the presently disclosed subject matter.

A component on the controller PCBA 360 is the main processor 365 representing the secure processor 314 block in FIG. 9. In at least one configuration the main processor 365 is an LPC55 series microcontroller component from NXP featuring two ARM core processors capable of instantiating up to military-grade encryption. In at least one configuration the main processor 365 is an LPC55S69JBD100 processor. It is contemplated that at least one of a wide variety of microprocessor components could be used in an implementation of the enclosed subject matter without divergence therefrom.

A primary structure configured for connection is provided by the main connector 363 attached to the controller PCBA 360. This structure configured for connection is used as a universal pathway hosting many power and communication lines from the block diagram of FIG. 9 including the sensor power 306, the secure signal 321, the PTZ commands 322, and the sensor orientation signal 342. In at least one configuration, the main connector 363 is a surface-mount receptacle suitable for board-to-board mounting. In at least one configuration the main connector 363 can physically and electrically mate with a Raspberry Pi header in a compatible and interoperable manner. In at least one configuration the main connector 363 is one of the Samtec HLE-120-02 series connectors.

In at least one configuration, an auxiliary connector 364 is connected to the controller PCBA 360. In at least one configuration the auxiliary connector 364 provides a structure configured to communicate. In at least one configuration the auxiliary connector 364 supports at least one serial wired communications protocol. In at least one configuration the auxiliary connector 364 is a USB compatible connector. In at least one configuration the auxiliary connector 364 is an Amphenol 10118192 series micro-USB connector.

An IMU module 367 is present as assembled onto the controller PCBA 360 representing the PNT module 312 from the block diagram of FIG. 9. In at least one configuration the IMU module 367 is a module containing a GNSS receiver and an IMU with at least three (3) axes of acceleration measurement. In at least one configuration the IMU module 367 is a u-blox NEO-M8U-06B component.

A magnetometer chip 366 is present as assembled onto the controller PCBA 360 representing the magnetometer 313 from the block diagram of FIG. 9. In at least one configuration the magnetometer chip 366 is a component containing at least three (3) axes of magnetic field measurement. In at least one configuration the magnetometer chip 366 is a component additionally containing at least three (3) axes of accelerometer measurement. In at least one configuration the magnetometer chip 366 is a STMicro ISM303DAC component.

An ISM radio module 369 is present as assembled onto the controller PCBA 360 representing the sensor radio 315 from the block diagram of FIG. 9. In at least one configuration the ISM radio module 369 is a Seeed 317990687 component.

In at least one configuration, the controller PCBA 360 can include at least one RF connector such as the sensor radio port 370 and the GPS port 368. In at least one configuration, at least one RF connector is a U.FL push-on connector with retention detent such as the U.FL-R-SMT (10) from Hirose Electric Co Ltd. In at least one other configuration, at least one of a variety of RF connectors can be used from a wide variety of subminiature, miniature, or standard size RF connection lines including, but not limited to, SMA, MMCX, SMPM, and others known and used by those skilled in the art of RF electronics design. In at least one configuration, a directly soldered cable end (e.g., “pigtail” to one of ordinary skill in the art) can similarly be used to save on component cost at the expense of increased assembly labor.

It is contemplated that sensors that employ the presently described feature(s) are particularly attractive for enhancing radio and sensor performance for any space, weight, power, and cost-constrained platforms such as air-dropped buoys, unattended radios/relay nodes, distributed sensors, uncrewed aircraft, handheld equipment, ground vehicle radios/sensor suites, and other compact, low-value, and/or attritable assets.

The foregoing description merely explains and illustrates the disclosure, and the disclosure is not limited thereto except insofar as the appended claims are so limited, as those skilled in the art who have the disclosure before them will be able to make modifications without departing from the scope of the disclosure.

1. A method of transmitting communications from a buoy placed in a body of water comprising the steps of:
first determining a first orientation of the buoy relative to a communication target;
second determining a second orientation of the buoy relative caused by the body of water;
third determining whether a transmission can reach the communication target; and
transmitting communications in a directional manner to the communication target if the step of determining determines that a transmission can reach the communication target.

2. The method of claim 1 wherein the step of second determining further comprises the steps of: determining one of the water swell and wave detection to determine proximity of the buoy to at least one of a peak or trough.

3. The method of claim 2 wherein the step of second determining further comprises the step of detecting velocity over integrated periods of time to determine periods of time with one of positive velocity and negative velocity.

4. The method of claim 2 wherein the step of transmitting communications further comprises the step of selecting a radio mode.

5. The method of claim 4 wherein the step of selecting the radio mode comprises the selection of a low data rate radio mode.

6. The method of claim 4 wherein the step of selecting the radio mode comprises the step of selection of a high data rate radio mode.

7. The method of claim 2 wherein the step of second determining further comprises the step of determining one of a global water apex and a local water apex.

8. The method of claim 7 wherein the step of transmitting communications further comprises the step of selecting a radio mode between a low data rate radio mode and a high data rate radio mode.

9. The method of claim 2 wherein the step of second determining further comprises the step of height determining a total height difference between the peak and trough.

10. The method of claim 9 wherein the step of height determining further comprises the step of designating a sea state.

11. The method of claim 1 wherein the step of third determining further comprises the step of determining the presence of an adjacent obstruction to at least one antenna associated with the step of transmitting.

12. The method of claim 11 wherein the step of third determining further comprises the step of determining if the adjacent obstruction is selected from one of the group consisting of: a volume of liquid water on the buoy, a volume of soil, dust or rocks, and foliage.

13. A sense-control unit comprising:
a body;
at least one inertial measurement unit (IMU) fixed to the body;
at least one magnetometer fixed to the body;
at least one microcontroller unit (MCU), structurally configured to issue control commands, and being coupled to the at least one IMU and the at least one magnetometer; and
at least one antenna structurally configured to transmit communication upon direction of the at least one microcontroller unit;
wherein the at least one MCU based upon information from the at least one IMU and the at least one magnetometer, determines a vector representation of the orientation and motion of the body, and the at least one MCU is configured to transmit communication through the at least one antenna upon determination of the acceptability of the same.

14. The sense-control unit of claim 13 wherein the at least one IMU, the at least one magnetometer and the at least one MCU are on the same printed circuit board (PCB).

15. The sense-control unit of claim 13 wherein the IMU further includes a sensor element that is structurally configured to measure acceleration in each of three cardinal directions relative to the body.

16. The sense-control unit of claim 14 wherein the IMU further includes second sensor elements that are structurally configured to measure rotational acceleration around each of three axial directions relative to the body.

17. The sense-control unit of claim 13 further including a positioning, navigation and timing (PNT) unit.

18. The sense-control unit of claim 17 wherein the PNT unit further includes a Global Navigation Satellite System (GNSS) receiver.

19. The sense-control unit of claim 13 wherein the body is one of a vehicle and a buoy.

20. The sense-control unit of claim 13 wherein the at least one antenna further includes at least one sensor to determine the presence of an adjacent obstruction to the at least one antenna.
